(19) United States
(12) Patent Application Publication
(10) Pub. No.: US 2015/0295629 A1
(43) Pub. Date: Oct. 15, 2015

(54) UNIFORM WLAN MULTI-AP PHYSICAL LAYER METHODS

(71) Applicant: INTERDIGITAL PATENT HOLDINGS, INC., Wilmington, DE (US)

(72) Inventors: Pengfei Xia, San Diego, CA (US); Oghenekome Oteri, San Diego, CA (US); Hanqing Lou, Syosset, NY (US); Monisha Ghosh, Chappaqua, NY (US); Robert L. Olesen, Huntington, NY (US); Nirav B. Shah, San Diego, CA (US)

(73) Assignee: INTERDIGITAL PATENT HOLDINGS, INC., Wilmington, DE (US)

(21) Appl. No.: 14/438,021

(22) PCT Filed: Oct. 25, 2013
(86) PCT No.: PCT/US13/66857

§ 371 Date: Apr. 23, 2015

Related U.S. Application Data
(60) Provisional application No. 61/719,081, filed on Oct. 26, 2012.
(60) Provisional application No. 61/751,503, filed on Jan. 11, 2013.

(51) Int. Cl. H04B 7/04; H04B 7/08; H04B 7/06

(52) U.S. Cl. CPC H04B 7/0491; H04B 7/061; H04B 7/0619; H04B 7/0695; H04B 7/088; H04W 88/08

(57) ABSTRACT

A method and apparatus are disclosed for training and feedback in sectorized transmissions. An IEEE 802.11 station may receive a Sector Training Announcement frame from an AP. The station may then receive a plurality of Training frames from the AP, wherein each of the plurality of Training frames is separated by a short interframe space (SIFS) and each of the plurality of Training frames is received using a different sectorized antenna pattern. The station may generate a Sector Feedback frame indicating a sector based on the plurality of Training frames. The station may send the Sector Feedback frame to the AP. The Sector Feedback frame may indicate a desire to enroll in sectorized transmissions. Alternatively, the Sector Feedback frame may indicate a desire to change sectors.

### CROSS REFERENCE TO RELATED APPLICATIONS

This application claims the benefit of U.S. provisional application No. 61/719,081 filed Oct. 26, 2012 and U.S. provisional application No. 61/751,503 filed Jan. 11, 2013, the contents of which are hereby incorporated by reference herein.

### BACKGROUND

Allowing simultaneous transmission to stations (STAs) from multiple access point (APs) may improve network coverage and throughput. However, current IEEE 802.11 specifications do not support this type of operation. The inability of a STA to associate with more than one AP at a time also limits network coverage. These limitations lead to inefficient use of the network's available resources. Because IEEE 802.11 does not support the simultaneous transmission from more than one AP to a single STA, methods which enable this operation are needed to facilitate better network coverage for STAs.

### SUMMARY

A method and apparatus are disclosed for training and feedback in sectorized transmissions. An IEEE 802.11 STA may receive a Sector Training Announcement frame from an AP. The STA may then receive a plurality of training frames from the AP, wherein each of the plurality of Training frames is separated by a short interframe space (SIFS) and each of the plurality of Training frames is received using a different sectorized antenna pattern. The STA may generate a Sector Feedback frame indicating a sector based on the plurality of Training frames. The STA may send the Sector Feedback frame to the AP. The Sector Feedback frame may indicate a desire to enroll in sectorized transmissions. Alternatively, the Sector Feedback frame may indicate a desire to change sectors.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows a uniform wireless fidelity (UniFi) system using a central controller for multi-AP transmissions;

FIG. 3 shows a UniFi system using coordination for multi-AP transmissions;

FIG. 4 illustrates multi-AP transmissions using a backhaul connection;

FIG. 5 shows how different cyclic shift diversity (CSD) may be used across multiple APs;

FIG. 6 is a flow diagram for adaptive CSD based on STA feedback;

FIG. 7 is a flow diagram for adaptive CSD based on AP signaling;

FIG. 8 illustrates spatial repetition across multiple APs;

FIG. 9 illustrates bit/symbol interleaving/deinterleaving with one common forward error correction (FEC) encoder;

FIG. 10 illustrates bit/symbol interleaving/de-interleaving with multiple FEC encoders;

FIG. 11 shows a format for modulation and coding scheme (MCS) feedback for multiple APs;

FIG. 12 illustrates a timing/frequency adjustment action frame;

FIG. 13 is a timeline diagram for a feedback procedure;

FIG. 14 shows a procedure for timing adjustment;

FIG. 15 shows a system which may use spatially coordinated Multi-AP (SCMA);

FIG. 16 illustrates a null data packet announcement (NDPA)/null data packet (NDP)/feedback procedure to enable SCMA;

FIG. 17 shows an NDPA frame format;

FIG. 18 shows a STA info field format for SCMA;

FIG. 19 shows a compressed beamforming frame action field format for SCMA;

FIG. 20 shows a Very High Throughput (VHT) multiple-input multiple-output (MIMO) control field format for SCMA;

FIG. 21 shows examples of open loop SCMA with synchronized data/acknowledgement (ACK) transmission;

FIG. 22 depicts two examples of open loop SCMA with unsynchronized data/ACK transmission;

FIG. 23 shows an example frame format for SCMA related frames;

FIG. 24 shows a system which may use joint precoded multi-AP (JPMA);

FIG. 25 illustrates an NDPA/NDP/feedback procedure to enable JPMA;

FIG. 26 shows an open loop procedure used by JPMA;

FIG. 27 illustrates omni transmission versus sectorized transmission;

FIG. 28 shows beacon transmission using sectorized transmission intervals;

FIG. 29 shows the transmission of an omni beacon followed by multiple directional beacons;

FIG. 30 shows an example sectorized transmission setup procedure;

FIG. 31 shows an example of a sectorized transmission switch protocol;

FIG. 32 depicts examples of implicit training and feedback mechanisms for sectorized transmission; and

FIG. 33 illustrates examples of explicit training and feedback mechanisms for sectorized transmission.

### DETAILED DESCRIPTION

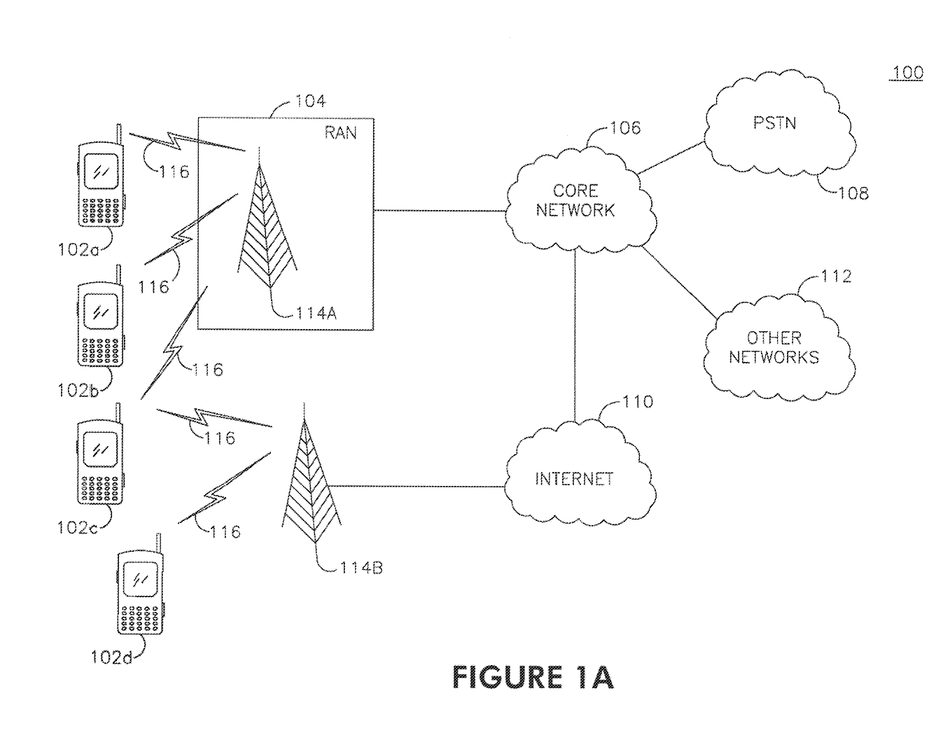

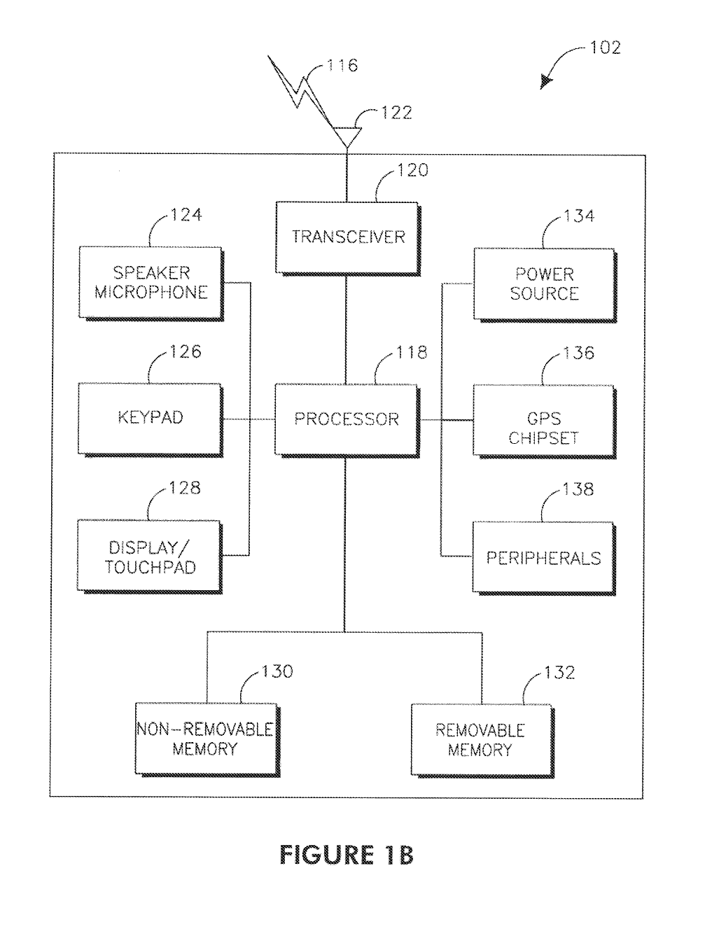

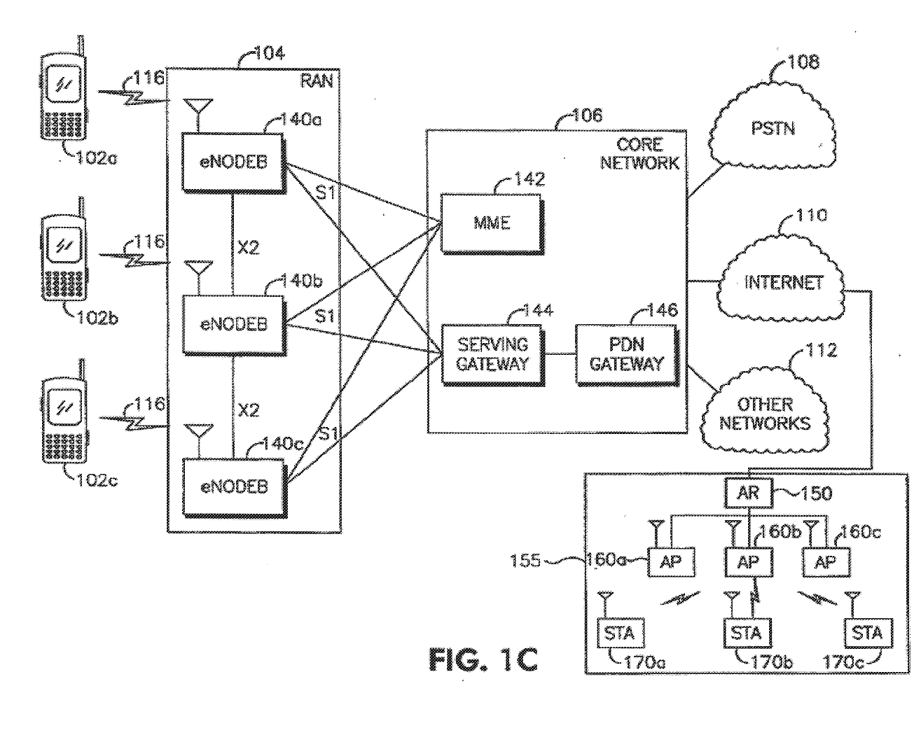

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices. An access router (AR) 150 of a wireless local area network (WLAN) 155 may be in communication with the Internet 110. The AR 150 may facilitate communications between APs 160a, 160b, and 160c. The APs 160a, 160b, and 160c may be in communication with STAs 170a, 170b, and 170c. The STAs 170a, 170b, 170c may be dual mode WLAN devices capable of performing WLAN operations while also being able to perform LTE operations like the WTRUs 102a, 102b, 102c. The APs 160a, 160b, and 160c and STAs 170a, 170b, and 170c may be configured to perform the methods disclosed herein.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Herein, the terminology “STA” includes but is not limited to a wireless transmit/receive unit (WTRU), a user equipment (UE), a mobile station, a fixed or mobile subscriber unit, an AP, a pager, a cellular telephone, a personal digital assistant (PDA), a computer, a mobile Internet device (MID) or any other type of user device capable of operating in a wireless environment. When referred to herein, the terminology “AP” includes but is not limited to a base station, a Node-B, a site controller, or any other type of interfacing device capable of operating in a wireless environment.

A WLAN in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is really peer-to-peer traffic. Such peer-to-peer traffic may also be sent directly between the source and destination STAs with a direct link setup (DLS) using an IEEE 802.11e DLS or an IEEE 802.11z tunneled DLS (TDLS). A WLAN using an Independent BSS (IBSS) mode has no AP, and STAs communicate directly with each other. This mode of communication is referred to as an “ad-hoc” mode of communication.

Using the IEEE 802.11ac infrastructure mode of operation, the AP may transmit a beacon on a fixed channel, usually the primary channel. This channel may be 20 MHz wide, and is the operating channel of the BSS. This channel may also be used by the STAs to establish a connection with the AP. The fundamental channel access mechanism in an IEEE 802.11 system is Carrier Sense Multiple Access with Collision Avoidance (CSMA/CA). In this mode of operation, every STA, including the AP, may sense the primary channel. If the channel is detected to be busy, the STA may back off. Hence only one STA may transmit at any given time in a given BSS.

In IEEE 802.11n, High Throughput (HT) STAs may also use a 40 MHz wide channel for communication. This is achieved by combining the primary 20 MHz channel with an adjacent 20 MHz channel to form a 40 MHz wide contiguous channel.

In IEEE 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to IEEE 802.11n described above. A 160 MHz channel may be formed either by combining 8 contiguous 20 MHz channels, or by combining two non-contiguous 80 MHz channels, this may also be referred to as an 80+80 configuration. For the 80+80 configuration, the data, after channel encoding, is passed through a segment parser that divides it into two streams. IFFT and time domain processing are done on each stream separately. The streams are then mapped on to the two channels, and the data is transmitted. At the receiver, this mechanism is reversed, and the combined data is sent to the medium access (MAC) layer.

Sub 1 GHz modes of operation are supported by IEEE 802.11af and IEEE 802.11ah. For these specifications the channel operating bandwidths are reduced relative to those used in IEEE 802.11n and IEEE 802.11ac. IEEE 802.11af supports 5 MHz, 10 MHz, and 20 MHz bandwidths in the TV White Space (TVWS) spectrum, and IEEE 802.11ah supports 1 MHz, 2 MHz, 4 MHz, 8 MHz, and 16 MHz bandwidths using non-TVWS spectrum. A possible use case for IEEE 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as IEEE 802.11n, IEEE 802.11ac, IEEE 802.11af, and IEEE 802.11ah, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of IEEE 802.11ah, the primary channel may be 1 MHz wide if there are STAs (e.g. MTC type devices) that only support a 1 MHz mode even if the AP and other STAs in the BSS may support a 2 MHz, 4 MHz, 8 MHz, 16 MHz, or other channel bandwidth operating modes. All carrier sensing and network allocation vector (NAV) settings depend on the status of the primary channel; i.e., if the primary channel is busy, for example, due to a STA supporting only a 1 MHz operating mode transmitting to the AP, then the entire available frequency band may be considered busy even though a majority of it stays idle and available.

In the United States, the available frequency band which may be used by IEEE 802.11ah is from 902 MHz to 928 MHz. In Korea it is from 917.5 MHz to 923.5 MHz; and in Japan, it is from 916.5 MHz to 927.5 MHz. The total bandwidth available for IEEE 802.11ah is 6 MHz to 26 MHz depending on the country code.

Coordinated multi-point (CoMP) transmission has been studied in Long Term Evolution (LTE) Release 10. In particular, multiple Evolved Node-Bs (eNBs) may transmit to the same UE in the same time and frequency resource using joint processing/transmission, with the objective of improving the overall throughput for the considered UE. Dynamic cell selection may be treated as a special case of joint processing in general. On the other hand, multiple eNBs may transmit to different UEs (each eNB serving its own UE) in the same time and frequency resource using coordinated beamforming/scheduling, with the objective of reducing interference experienced by each UE. Significant improvements of cell coverage and/or cell edge throughput may be achieved using CoMP in LTE.

The use of linear and nonlinear network coordinated beamforming in cellular networks to approach the multi-cell sum capacity assumes that all base stations serve their own UEs, and in the meantime keep the interference to other UEs at a minimum level. Multiple transmit antennas are assumed available for each base station. Simultaneous interference suppression (for other UEs) and signal quality optimization (for the desired UE) is accomplished through spatial domain signal processing at each base station.

In general, some degree of channel state information is assumed available at the base stations through, for example, explicit feedback. Also, a certain degree of timing/frequency synchronization is assumed such that more complicated signal processing to deal with inter-carrier interference (or inter-symbol interference) may be avoided.

One method to facilitate improved network coverage may be to allow the simultaneous transmission to STAs from multiple APs. However, as of the date of this document, the IEEE 802.11 specifications do not support this type of operation. Another limitation to the above is the inability of STAs to associate with more than one AP at the same time. This inability may limit the available network spectral efficiency.

Carrier Sense Multiple Access (CSMA) is used in IEEE 802.11n and 802.11ac. Using CSMA, STAs monitor the wireless channel, and transmit their pending data if the wireless channel is not occupied by other devices. STAs may need to perform a random backoff if the wireless medium is detected to be busy. As a result, multiple APs/STAs within a certain range cannot transmit at the same time. From the perspective of a single STA/AP, much of the time is spent on carrier sensing and/or backoff, especially for dense networks (e.g., networks which are comprised of a large number of STAs). This may cause relatively low network efficiency.

As noted above, IEEE 802.11 does not support simultaneous transmission from more than one AP. Methods which enable this operation are needed to facilitate better network coverage for STAs. This may also lead to an improvement of the user experience, a need for which recent trends in mobile user expectations have created.

Short training fields (STFs) are transmitted in the physical layer (PHY) header of the WLAN frame to enable coarse synchronization between the AP and STA. The STF may also be used for initialization of the automatic gain control (AGC), and for packet detection hypothesis for subsequent PHY processing. Long training fields (LTFs) are also transmitted in the PHY header of the WLAN frame to enable fine synchronization between the AP and STA.

As noted above, simultaneous transmission from more than one AP, in this document referred to as multi-AP operation, is required to support uniform coverage. Since the STF and LTF are designed for time division duplex (TDD) operation, and are not orthogonal, they cannot support multi-AP transmissions. Transmitting the same STF from multiple APs will cause interference which degrades the detection probability at the STA. Also since the STF is used to set the AGC at the receiver, a large variation in the STF power would result in undesired saturation (in the case of smaller STF power than data power), or quantization errors (in the case of larger STF power than data power). Accordingly, solutions which address coarse synchronization, initialization of the AGC, and packet detection are needed for multi-AP operation.

Physical layer signaling and associated procedures which enable the signaling as defined for IEEE 802.11ac are not sufficient to enable the multi-AP transmissions discussed above. For example, methods and procedures which control the choice of the error control code, coding rate, modulation parameters, spatial multiplexing schemes, and other related procedures may be needed. These requirements include a need to maintain backward compatibility with legacy WLAN systems.

To enable multi-AP transmissions, it may be necessary for the multiple participating APs to be synchronized in both the time and frequency domains. The IEEE 802.11ac specifications for time/frequency synchronization procedures cannot support multi-AP transmissions.

To enable improved cell coverage and improved spectral efficiency it may be desirable to consider coordination between APs for joint and coordinated transmission to STAs. This is referred to in this document as the Uniform Wireless Fidelity (UniFi) coverage use case for WLAN operation in next generation systems. As used herein, the WLAN refers to IEEE 802.11 compliant networks and devices.

As noted above, a possible method which may be used to improve coverage and spectral efficiency is multi-AP cooperation. The IEEE 802.11ac specifications do not support this method of transmission to STAs. Solutions are required which allow future WLAN systems to use multi-AP cooperation and coordination, and also allow existing legacy devices to operate in a multi-AP environment.

Channel state information (CSI) is required in IEEE 802.11ac to enable beamforming at the AP using explicit feedback. With the use of multi-AP cooperation, beamforming may be enhanced if the explicit feedback includes methods which further enable multi-AP cooperation and joint beamforming. For example, provisions may be needed to account for the inter-AP to inter-STA wireless channel.

Dense deployments of WLAN networks are becoming desirable for operators to improve the spectral efficiency and user experience for enterprise networks. The original design of WLANs did not consider the impact that such deployments would have on the efficiency of the network. For example, a dense network may exhibit a much higher probability for inter-BSS interference than has typically been observed of overlapping BSS (OBSS) deployments. Methods which address this interference in densely deployed networks may be needed.

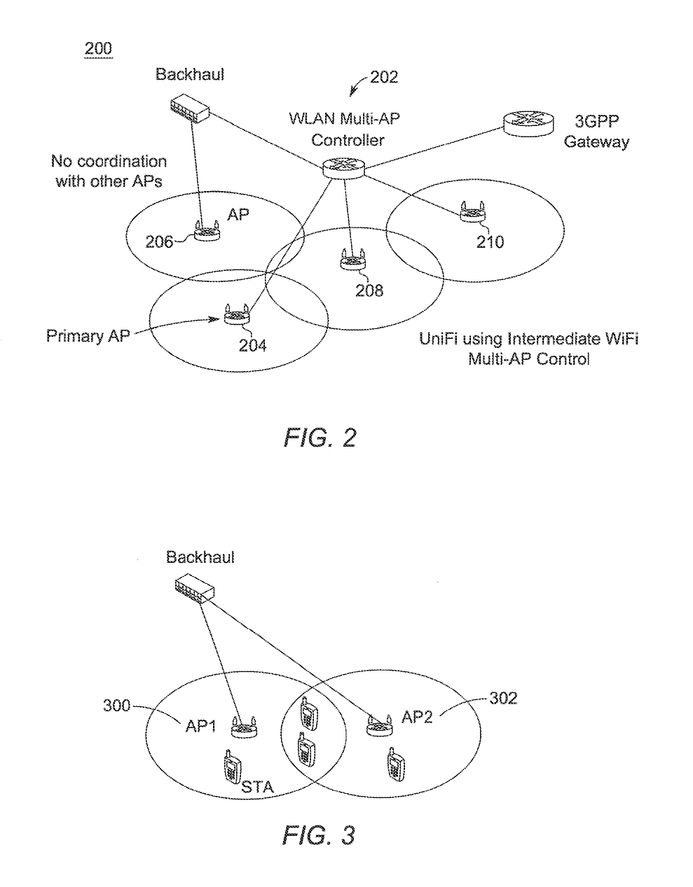

Embodiments which enable Multi-AP transmissions are described herein. In this document two system architectures are considered: (1) Central Control of Multi-AP Transmissions, depicted in FIGS. 2, and (2) Coordination of Multi-AP Transmissions, shown in FIG. 3. In FIG. 2, some or all of the APs which are associated with a WLAN controller may also be Remote Active Antennas (RAAs). In the system 200 shown in FIG. 2, the WLAN multi-AP controller 202 may physically reside in one of the APs 204-210. This AP, for example AP 204, may be referred to as the Primary AP. In FIG. 3, multi-APs 300, 302 coordinate with each other in sharing the channel medium, without a central controller.

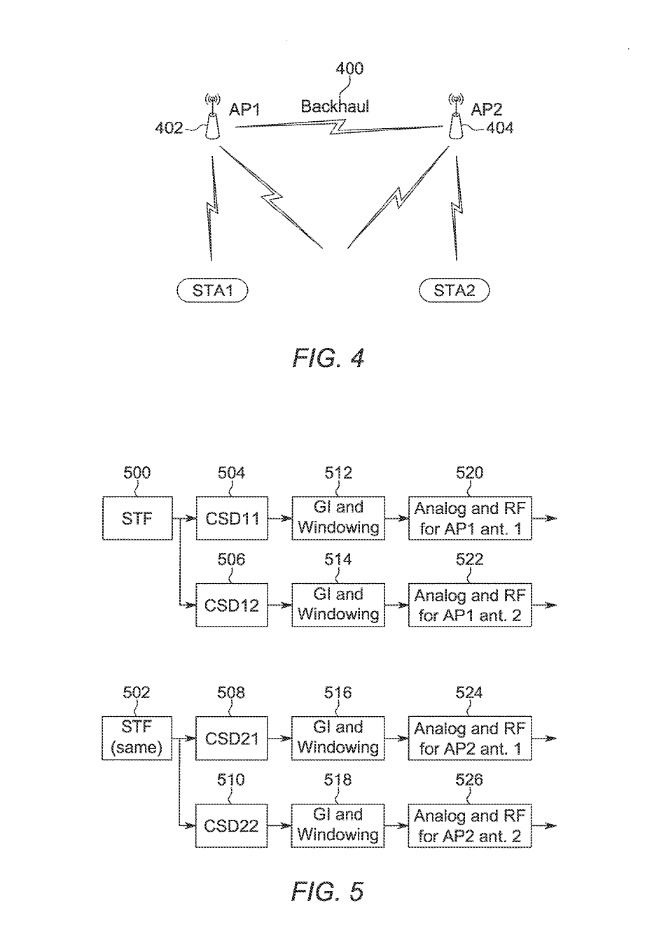

An overview of the embodiments is given below. A first embodiment describes methods which enable simultaneous multi-AP transmissions. Aspects covered include preamble training fields, SIG field and associated procedures, encoding, interleaving, and multiplexing. A second embodiment describes signaling and associated procedures for multi-AP coordination. Sounding and feedback procedures are also described which enable multi-AP coordination. STA grouping methods and procedures are also described for multi-AP transmissions. A third embodiment describes signaling and associated procedures for multi-AP joint precoding. Sounding and feedback procedures are also described to enable multi-AP joint precoding. In this document, multi-AP coordination enables multi-AP transmissions using the same, or different, data streams from each AP. Multi-AP coordination also assumes that data streams transmitted from each AP are considered interference to STAs that are not the intended recipient. FIG. 4 illustrates how a backhaul connection 400, either wired or wireless, between multiple APs 402, 404 may be necessary to enable the embodiments described herein.

The present embodiment considers adaptive cyclic shift diversity (CSD) for multi-AP STF. As noted above, problems arise when the same STF is transmitted from more than one AP at the same time. A possible solution to these issues is the use of CSD including associated procedures applied to STFs transmitted from multiple APs. A method which enables this solution is the use of a WLAN multi-AP controller as shown in FIG. 2.

Different cyclic phase delays may be applied for each AP to transmit the STF, as illustrated in FIG. 5. Two AP's may transmit the same STF 500, 502. Note that legacy STAs may not be able to detect the new UniFi packet, which may be used in a green field mode only. If multiple transmit antennas are employed at each AP, then different CSDs 504, 506, 508, 510 may also be applied across the more than one transmit antenna in each AP as well. Different combinations may be employed in applying the CSD across multiple APs, and multiple antennas within each AP. For each AP each stream, a separate Guard Interval is inserted and a time domain windowing 512, 514, 516, 518 may be applied. The signal, after GI insertion and windowing, is then sent to the corresponding analog part 520, 522, 524, 526 for transmission over the corresponding transmit antenna.

One example is given below in Table 1. The cyclic shift values shown in Table 1 are purely exemplary; other values may be used in this embodiment.

TABLE 1
Example of different CSDs applied to
multiple antennas across multiple APs

| | Cyclic shift | Cyclic shift | Cyclic shift | Cyclic shift |
|---|---|---|---|---|
| | (ns) for AP1 | (ns) for AP1 | (ns) for AP2 | (ns) for AP2 |
| Type | antenna 1 | antenna 2 | antenna 1 | antenna 2 |
| 1 | 0 | 100 | 0 | 200 |
| 2 | 0 | 100 | 50 | 150 |
| 3 | 0 | 100 | 0 | 100 |
| 4 | 0 | 50 | 200 | 250 |

The different propagation delay between AP1 and AP2 may serve as a virtual CSD to combat the undesired beamforming effect. The effectiveness of this virtual CSD may depend on the difference in the propagation delay. Thus, the exact cyclic shift value for each transmit antenna may depend on the delay spread between the STA and the APs. It may also be adaptively chosen.

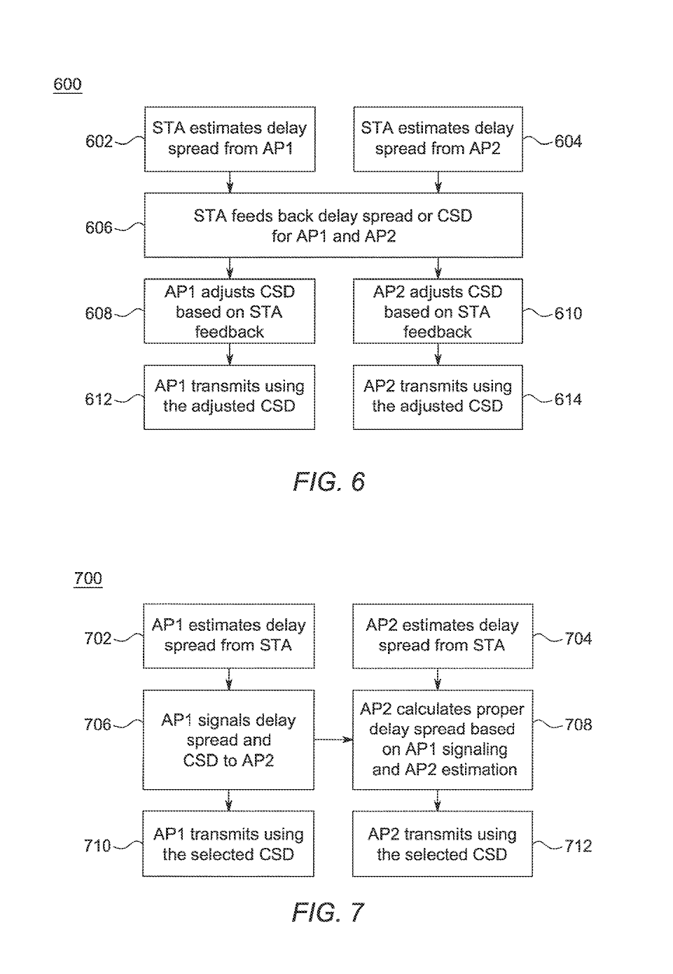

FIG. 6 shows a procedure 600 for providing the WLAN controller and/or associated APs with information for selecting a CSD. In one possible embodiment, a STA may estimate the channel delay spread between itself and AP1 using a detection of the transmitted STF and/or LTF, detection of the received pilots and/or received midamble symbols, or reception of a beacon frame from AP1 (step 602). The STA may then estimate the channel delay spread between itself and AP2 using a detection of the transmitted STF and/or LTF, detection of the received pilots and/or received midamble symbols, or reception of a beacon frame from AP2 (step 604). The STA may feedback a delay spread for AP1 and for AP2 (step 606). This feedback may be sent to one specific AP at a time, or may be aggregated and broadcast to multiple APs simultaneously. AP1 may adjust the delay spread to be used based on the delay spread feedback from the STA (step 608). AP2 may also adjust the delay spread to be used based on the delay spread feedback from the STA (step 610). Finally, AP1 may transmit using the adjusted CSD (step 612), and AP2 may transmit using the adjusted CSD (step 614).

This procedure may be performed once during the association of a STA in a multi-AP system, may be scheduled by one or more APs to occur under certain conditions, and/or may be scheduled to occur periodically. An example of a periodic schedule may be to associate this procedure with, or in accordance with, the reception of a particular beacon frame.

An alternative procedure 700 is illustrated in FIG. 7. AP1 may estimate the channel delay spread between itself and a STA using a detection of the transmitted STF and/or LTF, detection of the received pilots and/or received midamble symbols, or reception of a beacon frame from the STA (step 702). AP2 may estimate channel delay spread between itself and the STA using a detection of the transmitted STF, and/or LTF, detection of the received pilots and/or received midamble symbols, or reception of a beacon frame from the STA (step 704). AP1 may then select a cyclic shift to use based on the estimated channel delay spread. AP1 may send the selected CSD, its index, and/or the estimated delay spread to AP2 (step 706). The information element may be included in a management frame or clear to send (CTS)/request to send (RTS) response frame. AP2 may receive the selected CSD, its index, and/or the delay spread from AP1. AP2 may then adjust its cyclic shift based on the estimated delay spread and received info from AP1 (step 708). Finally, AP1 may transmit using the selected CSD (step 710), and AP 2 may transmit using the selected CSD (step 712). The apparatus shown in FIGS. 1B and 1C may be configured to perform the adaptive CSD procedure described herein. Specifically, the APs 170a, 170b and STA 102 may be configured to perform the methods described above and shown in FIGS. 6 and 7.

The adaptive CSD procedure may be performed once during the association of a STA in a multi-AP system, may be scheduled by one or more APs to occur under certain conditions, and/or may be scheduled to occur periodically. An example of a periodic schedule may be to associate this procedure with the reception of a particular beacon frame.

As disclosed below, when multiple orthogonal LTFs are used to perform channel estimation for each individual AP in a multi-AP system, an index may be assigned to the different LTFs. Each LTF index may be associated with a particular AP in the system. In addition, each AP may have more than one LTF index. The indices in the following description may correspond to one of multiple transmit antennas used by the AP in question.

In a related embodiment, the adaptive CSD values may be associated with the LTF index defined above. In particular, for all APs with the same LTF index, the same CSD values may be used. Note that it may be typical to assign different LTF indices to adjacent APs. APs using the same LTF indices may be widely separated, such that their respective channels would be uncorrelated.

In one embodiment, the same STFs may be transmitted from multiple APs. In this case, multiple APs may be treated as a single composite AP and may not be differentiated at the STA side (based on STFs). The use of a WLAN multi-AP controller as shown in FIG. 2 enables this solution.

Additionally, multiple orthogonal STF sequences may be transmitted from each AP. In this case, correlations with the multiple orthogonal STFs may enable the STA to differentiate each AP. For example, timing (frequency) synchronization may be performed separately for each AP and the obtained information may be used to further align the multiple APs in time (frequency).

A two-AP example is given below, though the general principle may be extended to N APs in a straightforward manner. In IEEE 802.11a, the legacy STF sequence is defined in the frequency domain as

STF_{—}1={S(−24)=1+j;S(−20)=−1−j;S(−16)=1+j;S(−12)=−1−j;

S(−8)=−1−j;S(−4)=1+j;S(4)=−1−j;S(8)=−1−j;

S(12)=1+j;S(16)=1+j;S(20)=1+j;S(24)=1+j;},

where S(n) refers to the STF signal in frequency tone n. Known signals may be transmitted from tones −24, −20, −16, −12, −8, −4, 4, 8, 12, 16, 20, 24, while all other tones may be zero. In multi-AP transmissions, the same STF_{—}1 may be transmitted from one AP.

Code division multiplexing (CDM) may enable orthogonal STFs to be transmitted from more than one AP. In this case, the STF_{—}2 sequence transmitted from AP2 may be

STF_{—}2={S(−24)=−1−j;S(−20)=−1−j;S(−16)=−1−j;S(−12)=1+j;

S(−8)=−1−j;S(−4)=−1−j;S(4)=1+j;S(8)=1+j;

S(12)=−1−j;S(16)=1+j;S(20)=1+j;S(24)=1+j;},

where STF_{—}2 is designed to be orthogonal to STF_{—}1 in time. Another set of known signals are transmitted from tones −24, −20, −16, −12, −8, −4, 4, 8, 12, 16, 20, 24, while all other tones are zero. It is noted that the STF_{—}2 sequence above maintains a 4-time repetition pattern, same as the original STF sequence STF_{—}1.

TDD transmission may be used as well to enable orthogonal STFs. In this case, the same STFs may be transmitted from multiple APs, one after another in time without overlapping. Frequency division duplex (FDD) may also be used to enable orthogonal STFs. In this case, the same STF sequence may be transmitted from multiple APs, occupying orthogonal subcarriers. The 4-time repetition pattern may be broken.

In the above example, a size 64 fast Fourier transform (FFT) is used. The same principle may be generalized to other size FFTs. Furthermore, a 4-time repetition pattern in the time domain is assumed for STF_{—}1 and STF_{—}2. This 4-time repetition pattern may or may not be maintained. Overall, other realizations of the STFs are possible.

At the receiver side, cross correlation may be used to find correlation with each of the STF sequence, leading to individual estimates of the timing and frequency synchronization parameters for all APs involved. Similarly, CDM/TDD/FDD may be used to enable orthogonal LTFs to be transmitted from multiple APs, such that channel estimation and fine time/frequency synchronization may be performed for each individual AP. When multiple orthogonal LTFs are used for channel estimation for each individual AP, an index may be given to the different LTFs, with each LTF index associated with a certain AP. Each AP may also have more than one LTF index, each index corresponding to one of multiple transmit antennas at the AP.

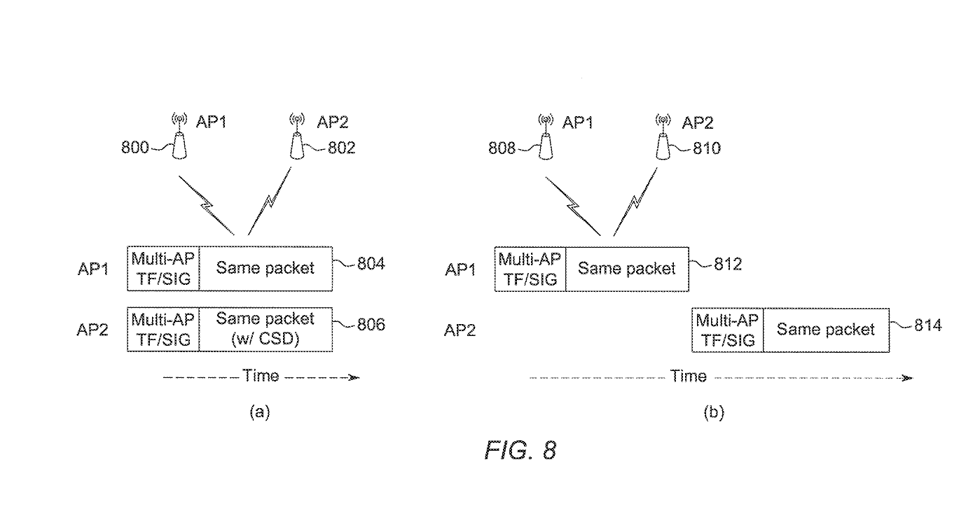

The present embodiment considers multi-AP encoding and interleaving in general, and specifically addresses multi-AP spatial repetition. In spatial repetition, the same data packet (data portion) may be transmitted from multiple APs, as illustrated in FIG. 8. This may be enabled by the use of a WLAN multi-AP controller as in FIG. 2, by the use of a bridge architecture at the IP layer, or by coordination at the IP layer. This embodiment may be further enabled by MAC procedures which address the scheduling of packets for transmission to more than one AP.

In the embodiment shown in FIG. 8(a), a data packet 804 may be transmitted from AP1 800. The same packet with CSD 806 may be transmitted simultaneously from AP2 802. CSD may be applied on the data packet in the same manner as described above for adaptive CSD for multi-AP STF. For the embodiment shown in FIG. 8(b), the same data packet 812, 814 may be transmitted from the two APs 808, 810, one after another. In this case, the receiver may choose to coherently combine the signals from both APs, or may choose to select the transmission from the stronger AP. In both of the above embodiments a packet transmission may be repeated from more than one AP, and/or more than one subset of the antennas deployed in a network.

Another possible embodiment is to transmit different encoded copies of the same information bits from two APs. For example, when a rate 1/2 convolutional encoder is used, the systematic bits may be transmitted from one AP, while the parity bits may be transmitted from another AP.

An alternative embodiment may apply a distributed Space Time Block Code (STBC) across multiple APs. For example, for every pair of information symbols [s1, s2] transmitted from AP1, the corresponding pair of information symbols [−s2*, s1*] may be transmitted from AP2 during the same symbol-pair duration.

It is noted that the same data packets are repeated from multiple APs as discussed above, which may imply that the same modulation and coding scheme (MCS) is used for each AP involved. In general, although the same information bits may be transmitted from each AP, different MCSs may be used. For more details, see below regarding unequal MCS for multi-AP operation.

The following embodiment describes bit/symbol interleaving across multiple APs, or multiple remote active antennas (RAAs). The use of a WLAN multi-AP controller as shown in FIG. 2 may enable this solution.

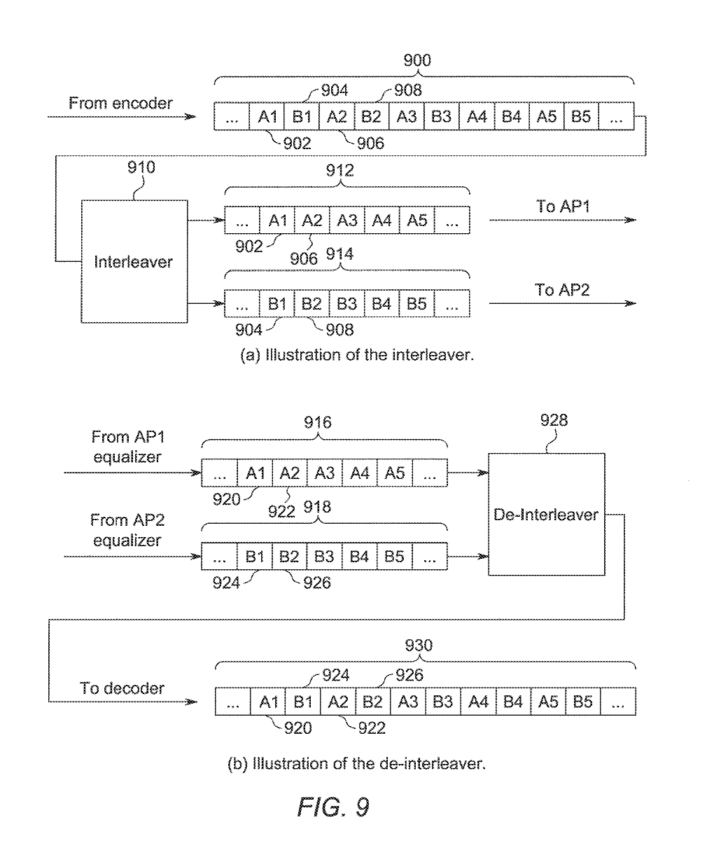

Two embodiments are described herein. In a first embodiment, a single forward error correction (FEC) encoder is used to encode bits that are to be distributed to two APs, or RAAs, for transmission. Spatial multiplexing from the two APs, or RAAs, may be used. The encoded bits (or symbols if interleaving happens after the constellation mapping) may be interleaved, e.g., following the illustration in FIG. 9(a). Each block in FIG. 9(a) may represent a block of consecutive encoded bits, or a block of consecutive symbols (after constellation mapping).

Interleaving may be done such that adjacent blocks (of bits/symbols) are mapped and transmitted across different APs in a multi-AP system. In an exemplary procedure, the encoder (e.g. a convolutional encoder or a low density parity check (LDPC) encoder) encodes the incoming information bits. This may be enabled by the use of a WLAN multi-AP controller as in FIG. 2, by the use of a bridge architecture at the IP layer, or by coordination at the IP layer.

As shown in FIG. 9(a), the encoded bit stream 900 may be divided into multiple blocks (e.g., A1 902, B1 904, A2 906, B2 908, etc.) and delivered to the interleaver 910. The interleaver 910 may reshuffle the incoming bit stream 900 into two output bit streams 912, 914. The reshuffling may be done such that adjacent blocks are distributed into different bit streams. For example, as shown in FIG. 9(a), blocks of bits/symbols A1 902, A2 906, etc. are distributed into the first stream 912, and blocks of bits/symbols B1 904, B2 908, etc. are distributed into the second stream 914.

The first bit stream 912 output from the interleaver 910 may be modulated using a certain constellation mapping, spatially mapped using a first set of spatial mapping vectors, OFDM modulated, and transmitted from the Primary AP. The second bit stream 914 output from the interleaver 910 may be modulated using another constellation mapping, spatially mapped using a second set of spatial mapping vectors, OFDM modulated, and transmitted from one or more of the non-primary APs. Such an interleaving scheme may help reduce bursty error patterns, and may also be helpful when the encoder is vulnerable to bursty errors (e.g., a convolutional encoder).

At the receiver side, deinterleaving may be necessary. As illustrated in FIG. 9(b), the equalizer outputs from AP1 and AP2 may be de-interleaved to restore the original ordering of the transmitted packet. In an exemplary procedure, the STA may decode a capability indication from the primary AP or the WLAN controller. If the capability indication indicates the use of multi-AP operation, the STA may determine whether it should decode multiple parallel packets in a multi-AP system. The above may be enabled using an indication in the signal (SIG) field of the preamble.

The STA may then perform separate equalization/demodulation for the first stream 916 sent from AP1 and the second stream 918 sent from AP2. The first soft bit stream 916 may be divided into multiple blocks (e.g. A1 920, A2 922, etc.) and entered into the deinterleaver module 928. The block size may be pre-determined, and may be the same as the block size at the interleaver 910. The second soft bit stream 918 may be divided into multiple blocks (e.g. B1 924, B2 926, etc.) and entered into the deinterleaver module 928. The block size may be pre-determined, and may be the same as the block size at the interleaver 910. The deinterleaver module may arrange the two soft bit streams 916, 918 into one bit stream 930 to restore the original ordering. The deinterleaved bit stream 930 may then be sent to the decoder for FEC decoding.

More than one FEC encoder may be used in general to accommodate multiple APs (or RAAs). Two FEC encoders and two APs (or two RAAs) are used as an example herein. Spatial multiplexing from the two APs (or RAAs) may be assumed herein as well. It is noted that the FEC encoders described below may be included in a WLAN controller, wherein the bits may be distributed to multiple APs as shown in FIG. 2.

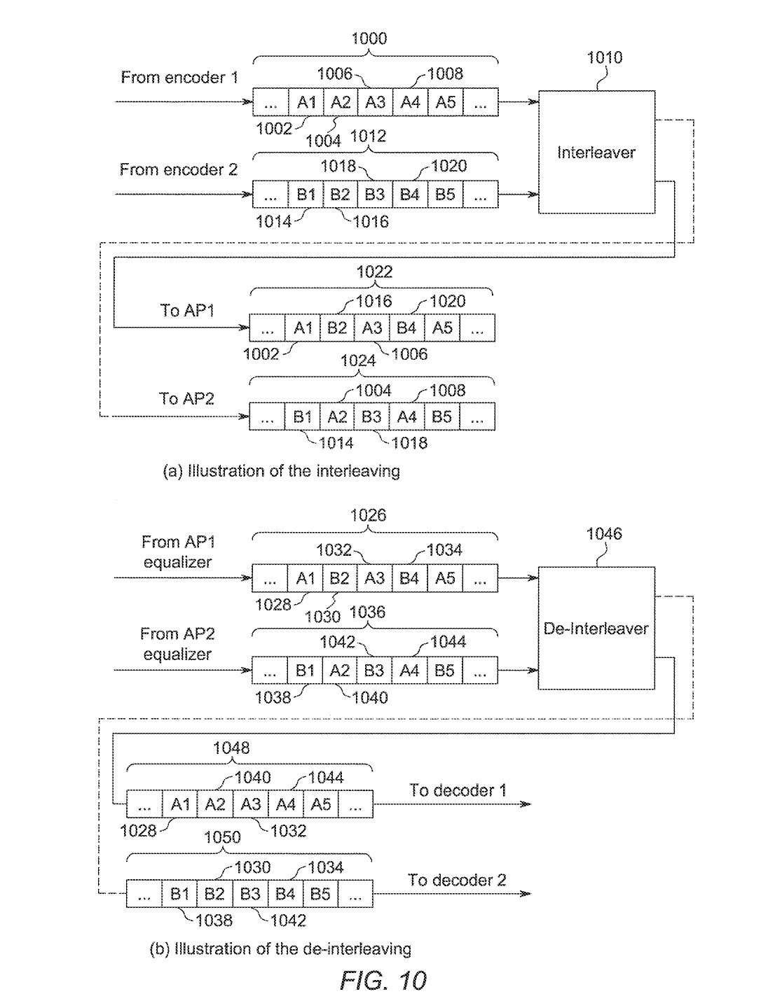

The encoded bits from encoder 1 and encoder 2 may be interleaved as illustrated in FIG. 10, where each block may represent a block of consecutive encoded bits, or a block of consecutive symbols (after constellation mapping). Effectively, the bit streams from encoder 1 and 2 may be twisted and intertwined before they are sent. For each convolutional encoder, adjacent coded bits may be mapped and transmitted across different APs. An exemplary procedure, depicted in FIG. 10(a), is given below.

The first encoder (e.g., a convolutional encoder or a LDPC encoder) may encode the incoming information bits. This may happen within a WLAN controller. The second encoder (e.g., a convolutional encoder or a LDPC encoder) may also encode the incoming information bits. This may also happen within a WLAN controller. The first encoded bit stream 1000 may be divided into multiple blocks (e.g. A1 1002, A2 1004, A3 1006, A4 1008, etc.) and entered into the interleaver 1010. This may happen within a WLAN controller. The second encoded bit stream 1012 may be divided into multiple blocks (e.g. B1 1014, B2 1016, B3 1018, B4 1020, etc.) and entered into the interleaver 1010. This may also happen within a WLAN controller. The interleaver 1010 may interleave the two incoming bit streams into two different output bit streams. The reshuffling may be done such that for each incoming stream, adjacent blocks are distributed into different bit streams. For example, as shown in FIG. 10(a), blocks of bits/symbols A1 1002, B2 1016, A3 1006, B4 1020, etc. may be distributed into the first stream 1022. Blocks of bits/symbols B1 1014, A2 1004, B3 1018, A4 1008, etc. may be distributed into the second stream 1024. This may also happen within a WLAN controller.

The first bit stream 1022 output from the interleaver 1010 may be modulated using a certain constellation mapping, spatially mapped using a first set of spatial mapping vectors, OFDM modulated, and then transmitted from the first AP. This may happen within the first AP. The second bit stream output from the interleaver may be modulated using another constellation mapping, spatially mapped using a second set of spatial mapping vectors, OFDM modulated, and then transmitted from the second AP. This may happen within the second AP.

Similar to the interleaving scheme shown in FIG. 9(a), the interleaving scheme illustrated in FIG. 10(a) may help reduce burst error patterns, and may also be helpful when the encoder is vulnerable to bursty errors.

At the receiver side, deinterleaving may be employed. As illustrated in FIG. 9(b), the equalizer outputs from AP1 and AP2 may need to be de-interleaved to restore the original ordering information for each FEC encoder. In an exemplary procedure, the STA may perform separate equalization/demodulation for the first stream 1026 sent from AP1 and the second stream 1036 sent from AP2.

The first soft bit stream 1026 may be divided into multiple blocks (e.g. A1 1028, B2 1030, A3 1032, B4 1034, etc.) and entered into the deinterleaver module 1046. The block size may be pre-determined, and may be the same as the block size at the interleaver 1010. The second soft bit stream 1036 may be divided into multiple blocks (e.g. B1 1038, A2 1040, B3 1042, A4 1044, etc.) and entered into the deinterleaver module. The block size may be pre-determined, and may be the same as the block size at the interleaver 1010.

The deinterleaver module may arrange the two soft bit streams 1026, 1036 into two bit streams 1048, 1050 to restore the original ordering for each bit stream. As shown in FIG. 10(b), the blocks of bits A1 1028, A2 1040, A3 1032, A4 1044, etc. are restored in order in the first bit stream 1048. The blocks of bits B1 1038, B2 1030, B3 1042, B4 1034, etc. are restored in order in the second bit stream 1050. The first deinterleaved bit stream 1048 may then be sent to the first decoder for FEC decoding. The second deinterleaved bit stream 1050 may then be sent to the second decoder for FEC decoding.

In the interleaving and deinterleaving processes described above, the interleaving pattern of an AP (RAA) may be linked with an LTF indicex. As is discussed above, when multiple orthogonal LTFs are used for channel estimation from each individual AP (or RAA), an index may be given to the different LTFs, with each LTF index associated with a certain AP (or RAA). Each AP (or RAA) may have more than one LTF index though, potentially corresponding to multiple transmit antennas within that AP (RAA).

The interleaving pattern of each AP (RAA) may be linked with its LTF indices. In particular, for all APs (or RAAs) with the same LTF index, the same interleaving pattern may be used. Typically, different LTF indices may be assigned to adjacent APs (RAAs). As a result, APs (RAAs) with the same LTF indices would typically be fairly separated from each other. An example procedure for the above is described below.

Each transmit AP may be assigned an LTF index. For example, AP1 may be assigned LTF index 1, and AP2 may be assigned LTF index 2. LTF index 1 and LTF index 2 may be designed to be orthogonal to each other. The WLAN controller may read the LTF index for AP1 and the LTF index for AP2 (index 1 and 2 in the example above). The WLAN controller may use the read LTF indices to control the interleaver.

The apparatus depicted in FIGS. 1B and 1C, and specifically the APs 170a, 170b and STA 102d in FIG. 1C, may comprise a modulator, an encoder, an interleaver, and a deinterleaver. The APs 170a, 170b and the STA 102d may be configured to process bit streams according to the steps described above and illustrated in FIGS. 9 and 10.

The following embodiment considers unequal MCS for multi-AP operation. In multi-AP transmission, it is possible that the effective channels from each AP (to the STA) may differ in channel quality. In such a scenario, the APs may decide to use different MCSs for transmissions. This may be motivated by the need for a similar quality of service (QoS) metric (such as frame error rate (FER)) for each independent AP transmission. In an example in which AP2 has a weaker channel than AP1, a smaller MCS may be used for AP2 transmissions to ensure that the same QoS is achieved from the two APs.

Another motivation for using different MCSs for transmission may be the need for different QoS metrics for each independent AP transmission. For example, to facilitate a successive interference cancellation receiver, different MCSs may be used across multiple APs to create imbalanced links across multiple APs. In an example in which both independent channels are of the same quality, a smaller MCS may be used for AP1 transmissions and a larger MCS for AP2 transmissions, such that AP1 transmissions may be decoded with higher reliability, with the AP1 decoder output being used for successive interference cancellation in AP2 decoding.

To have unequal MCSs across multiple APs, it may be necessary to have to have some sort of feedback. For example, feedback of the desired MCS or estimated signal to interference plus noise ratio (SINR) from the receiving STA to each of the transmitting APs may be provided, as well as signaling of the transmitted MCS from each transmitting AP to the receiving STAs. The following illustrates a procedure as well as the enabling signaling fields for the example of one receiving STA and two transmitting APs.

The STA may estimate the channels from each transmitting AP (or RAA). The estimation may be based on the received STFs/LTFs from the transmitting APs, and/or received pilots, and/or received midamble symbols, or reception of a beacon frame. Multiple orthogonal STFs/LTFs may need to be transmitted, with one set of STFs/LTFs for each transmitting AP (or RAA). In contrast, only one AP may transmit at a time in IEEE 802.11ac. For this reason, only one set of STFs/LTFs is needed to enable successful channel estimation.

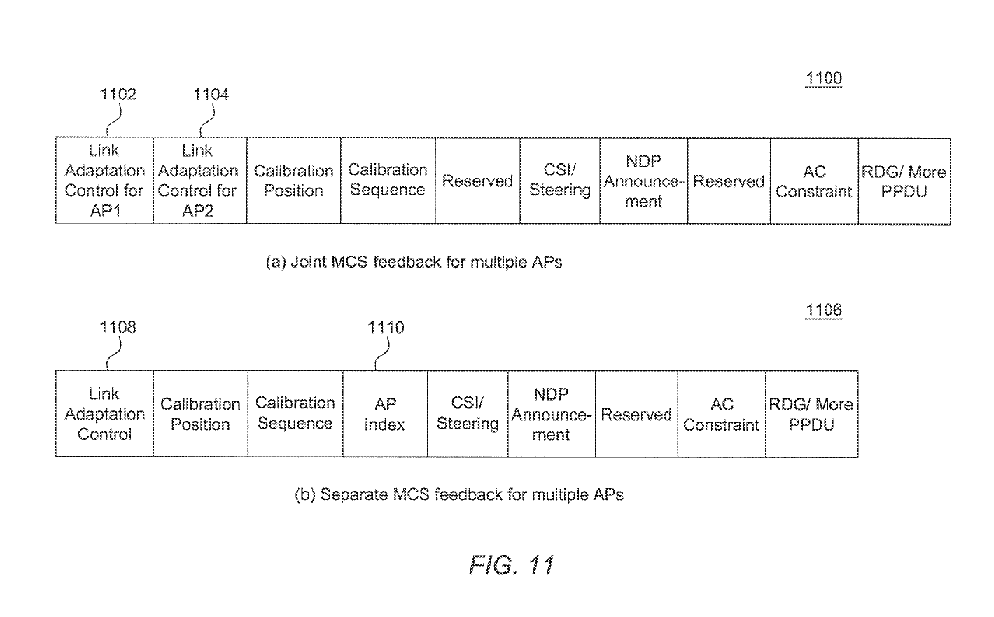

The STA may choose the optimal MCS for each AP, and may send it back to the AP. The STA may re-use the Link Adaptation Control sub-field in the high throughput (HT) control field to feedback unequal MCSs. This may be done jointly, as in the HT control field 1100 illustrated in FIG. 11(a), where the suggested MCS for AP1 is contained in the Link Adaptation Control for AP1 field 1102 and the suggested MCS for AP2 is contained in the Link Adaptation Control for AP2 field 1104.

Alternatively, the MCS may be individually fed back to each AP with the reserved bits 1110 in the HT control field 1106 indicating the index of the AP in the UniFi set, as illustrated in FIG. 11(b). In this case, the suggested MCS for this particular AP may be contained in the Link Adaptation Control field 1108. An estimated SINR for each transmitting AP may also be fed back within the corresponding VHT compressed beamforming report. For more details, see below regarding feedback for spatially coordinated Multi-AP (SCMA).

The multi-AP transmission may be viewed as a multi-stream transmission from a super-AP. In contrast, the IEEE 802.11ac standard allows for only a single MCS to be used in the case of multi-stream transmission. For this reason, changes may be needed to support feedback for more than one MCS.

Upon receiving the MCS feedback from the STA, an AP may choose to follow the STA's MCS recommendation, or to override the MCS recommendation. In general, it may be necessary for the multiple APs to signal the selected MCSs used from each AP. This may require a modification to the SIG field. The signaling may be done in one of the following ways.

Separate MCSs may be used for each AP. In this case, the signal (SIG) preamble fields from multiple APs may be different, and orthogonal transmissions of SIG fields may be needed. TDD may be used to enable orthogonal SIG fields. In this case, the SIG field elements may be identical except for the MCS or rate element and may be transmitted from multiple APs one after another in time without overlapping. Alternatively, a super MCS may be used that indicates the MCS of each AP in a pre-determined order. In this case, a setup procedure that establishes ordering of the multiple APs may be implemented and the SIG field (containing the super MCS) may be transmitted simultaneously from each AP. Finally, a single SIG field from the primary AP may be used. In this case, a setup procedure may establish the ordering of the multiple APs and designate one of the APs as the primary AP. The SIG field (containing a super MCS based on the AP ordering) may be transmitted from the primary AP only. In contrast, only one AP may transmit at a time in IEEE 802.11ac. For this reason, only one MCS is signaled in the SIG field.

Orthogonal STFs/LTFs across multiple APs as discussed above may be used to enable separate timing and/or frequency synchronization for each AP in a multi-AP system. Methods which allow enhanced feedback and procedures for multi-AP feedback to support timing/frequency synchronization are described herein. The feedback may be time domain feedback indicating a timing advance or timing retardation. The feedback may be frequency domain feedback indicating a forward frequency rotation or backward frequency rotation. Alternatively, the feedback may be multi-field feedback indicating that the feedback is either a time domain or frequency domain feedback and a value indicating the amount of adjustment required.

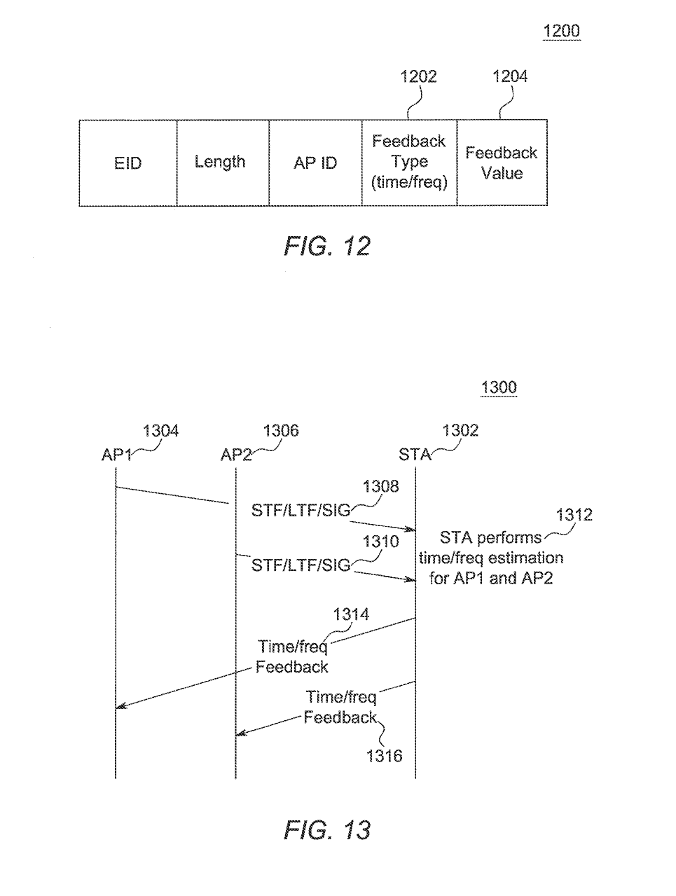

FIG. 12 shows an example of a timing/frequency adjustment frame 1200. The timing/frequency adjustment frame 1200 includes a feedback type (time/frequency) field 1202 and a feedback value field 1204. An AP which performs the timing/frequency adjustment may send back a timing/frequency adjustment ACK to the STA(s) using either an existing modified ACK management frame, or a new management frame, to indicate that it has performed the adjustment or prefers not to perform the adjustment. An exemplary timing/frequency adjustment procedure is described below.

The primary AP and/or additional AP(s) may broadcast, or otherwise indicate, a timing/frequency synchronization tolerance to STAs which are scheduled for communication with the AP. A timing/frequency synchronization tolerance may also be a predetermined parameter specified either directly, or implied, using an AP capability information element. Referring to FIG. 13, the STA may use the timing/frequency information to perform the method 1300.

The STA 1302 may estimate the timing/frequency estimation error at the STA 1302 for AP1 1304 and AP2 1306 using a detection of the transmitted STF and/or LTF, detection of the received pilots and/or received midamble symbols, or reception of a beacon frame.

Using the information 1308, 1310 from AP1 1304 and AP2 1306, the STA 1302 may respond to the APs 1304, 1306 by transmitting a timing/frequency adjustment information element 1314, 1316 to one, or more than one, AP. The information element may be included in a management frame or CTS/RTS response frame. The response may be sent to a specific AP, or may be aggregated and broadcast to the multiple APs simultaneously.

This procedure may be performed once during association of a STA in a multi-AP system, and/or may be scheduled by one or more APs to occur under certain conditions, and/or may be scheduled to occur periodically. An example of a periodic schedule may be to associate this procedure with the reception of a particular beacon frame.

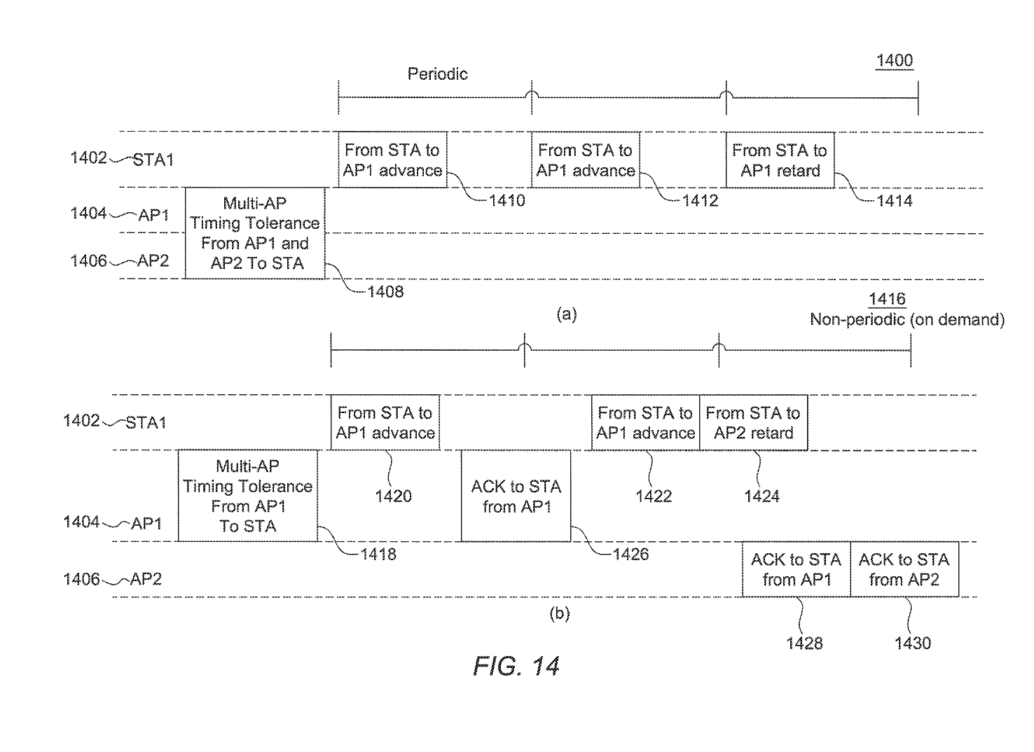

An alternative to the adjustment value of this method may be to set a specific granularity in the timing/frequency adjustment frame which indicates a specific number of adjustments to the STA, as illustrated in FIG. 14. In the first procedure 1400, the information 1408 from the APs 1404, 1406 is jointly transmitted and the STA 1402 transmits periodic adjustments 1410, 1412, 1414 to AP1 1404 relative to AP2 1406. In the second procedure 1416, the information 1418 from each AP 1404, 1406 is transmitted independently, and the STA 1402 adjusts each AP independently 1420, 1422, 1424, and expects to receive an acknowledgement (ACK) 1426, 1428, 1430 from the AP 1404, 1406 indicating whether it made the update.

In a scenario in which there are multiple STAs, the APs may decide to synchronize their timing independent of the STAs. In this case, AP1 may use the signaling discussed above to request a timing/frequency advance or retardation of the signal from AP2.

In the following embodiment a spatially coordinated multi-AP (SCMA) mode of WLAN operation may enable two or more APs in a cell to simultaneously transmit to more than one STA at the same time. This embodiment considers solutions with the physical layer, although other embodiments may be possible in the MAC layer.

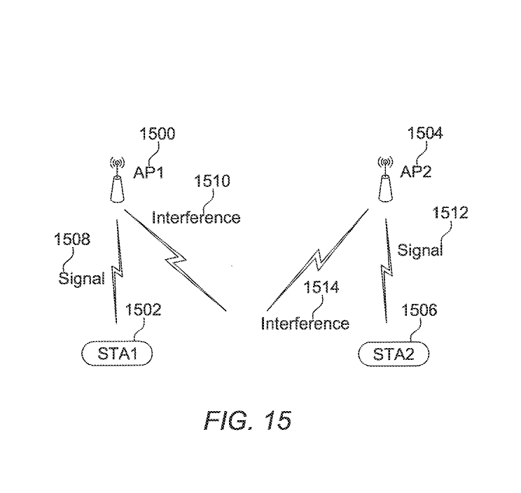

Consider the example illustrated in FIG. 15, in which AP1 1500 serves STA1 1502, and at the same time AP2 1504 serves STA2 1506. There is not necessarily a wired connection between AP1 1500 and AP2 1506. In this case, it may be desirable for AP1 1500 to form a beam 1508 toward its desired STA 1502 while also creating a null toward the undesired STA 1506. At the same time, AP2 1504 may form a beam 1512 toward its desired STA 1506 while creating a null 1514 toward its undesired STA 1502.

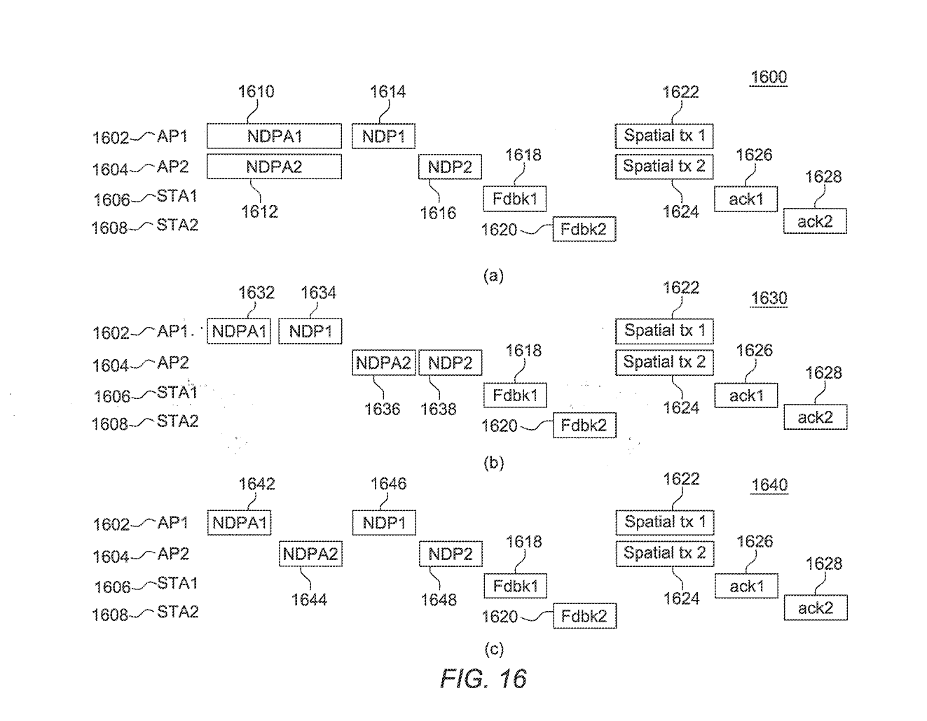

The following embodiment describes a procedure 1600, depicted in FIG. 16(a), which enables SCMA. AP1 1602 and AP2 1604 send out null data packet announcement (NDPA) frames 1610, 1612. The NDPA frames 1610, 1612 announce that null data packet (NDP) frames from AP1 1602 and AP2 1604 may follow. This may help the intended STAs (STA1 1606 and STA2 1608) prepare for channel estimation and feedback.

AP1 1602 may send out a null data packet (NDP) frame 1614. The NDP1 frame 1614 may be used by STA1 1606 to estimate the wireless channel between AP1 1602 and STA1 1606. The NDP1 frame 1614 may also be used by STA2 to estimate the wireless channel between AP1 1602 and STA2 1608.

AP2 1604 may send out an NDP frame 1616. The NDP2 frame 1616 may be used by STA2 1608 to estimate the wireless channel between AP2 1604 and STA2 1608. The NDP2 frame 1616 may also be used by STA1 1606 to estimate the wireless channel between AP2 1604 and STA1 1606.

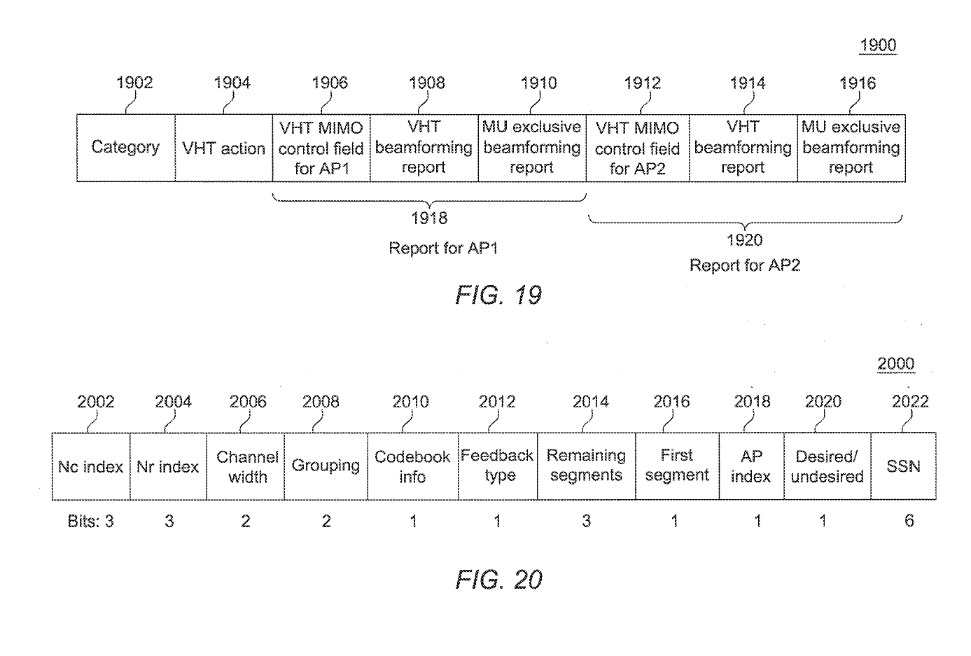

STA1 1606 may send feedback 1618. STA1's feedback 1618 may include a desired beam from AP1 1602. STA1's feedback 1618 may also include an undesired beam from AP2 1604. STA2 1608 may send feedback 1620. STA2's feedback 1620 may include a desired beam from AP2 1604. STA1 and STA 2 may use the feedback frame format discussed below and shown in FIGS. 19 and 20.

AP1 1602 and AP2 1604 may compute the transmit beamforming vectors and may start actual data transmissions 1622, 1624 at the same time. AP1 1602 may form a beam toward its desired STA1 1606, and may create a null toward its undesired STA2 1608. AP2 1604 may form a beam toward its desired STA2 1608, and may create a null toward its undesired STA1 1606. STA1 1606 and STA2 1608 may send out acknowledgement (ACK) messages 1626, 1628.

The above procedure 1600 is illustrated in FIG. 16(a), where NDPA frames 1610, 1612 from AP1 1602 and AP2 1604 are transmitted at the same time, possibly using CSD as described above. In this case, both NDPA frames 1610, 1612 may be identical. It is noted that backhaul communications between AP1 1602 and AP2 1604 may be needed here such that the same NDPA frames 1610, 1612 may be prepared at AP1 1602 and AP2 1604 and transmitted at the same time.

A slight variation of the above procedure 1600 is shown in FIG. 16(b). In the procedure 1630, NDPA1 1632 and NDP1 1634 from AP1 1602 may be transmitted together, followed by NDPA2 1636 and NDP2 1638 from AP2 1604.

Another slight variation of the above procedures 1600, 1630 is shown in FIG. 16(c). In the procedure 1640, NDPA1 1642 from AP1 1602 and NDPA2 1644 from AP2 1604 may be transmitted one after another. These may be followed by NDP1 1646 from AP1 1602 and NDP2 1648 from AP2 1604, again transmitted one after another.

The following embodiment describes sounding for SCMA. As described above, the downlink channel may need to be estimated, and the estimate may then be fed back to the APs. To achieve this, sounding packets (NDPA and NDP frames) may be transmitted first. Specifically, the NDPA frame may be used to announce that NDP frames from AP1 and AP2 will follow. This may help the intended STAs prepare for channel estimation and feedback.

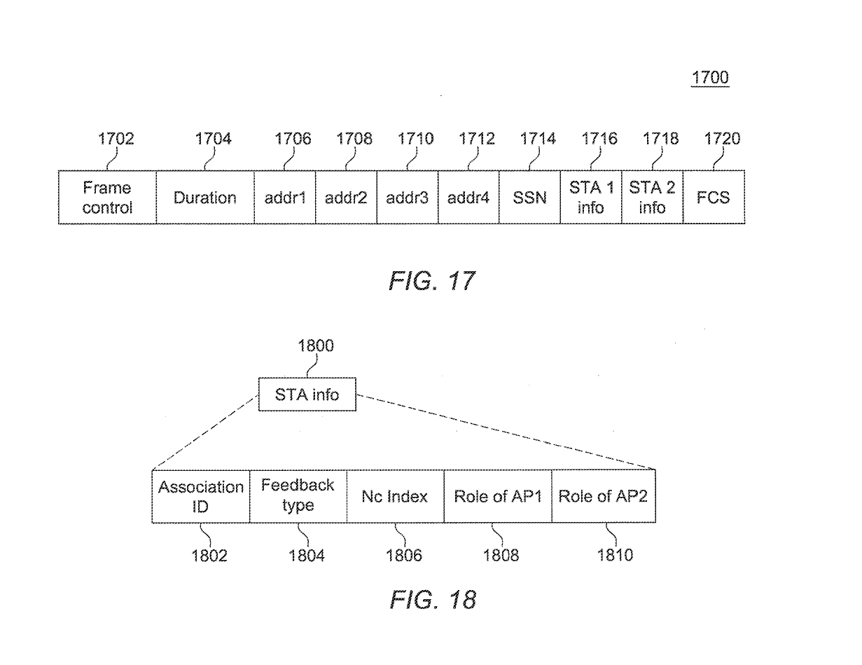

For multi-AP communications, the NDPA frame may take a format as illustrated in FIG. 17. The NDPA frame 1700 may comprise a Frame control field 1702 that specifies various control elements used to process the frame. The duration field 1704 may specify the estimated time needed to complete the signaling exchanges plus data delivery as illustrated in FIG. 16. The Addr1 field 1706 and Addr2 field 1708 may specify the MAC address of AP1 and AP2, respectively. The Addr3 field 1710 and Addr4 field 1712 may specify the MAC address of STA1 and STA2, respectively. The SSN field 1714 may specify the sounding sequence number associated with the current sounding. The STA1 info field 1716 may specify the information for STA1, and the STA2 info field 1718 may specify the information for STA2. The frame check sequence (FCS) field 1720 may be used to provide a cyclic redundancy check (CRC) for the entire frame.

The NDPA frame format may be generalized to cover the case in which more than two APs and/or more than two STAs are involved in the SCMA procedure. In such a case, the new NDPA frame format may include the MAC address of each AP involved, the MAC address of each STA involved, and also a STA info field for each STA involved.

In the above, the STA info field may take a form as illustrated in FIG. 18. The STA info field 1800 may contain an Association ID field 1802 that contains the association ID of the STA that is expected to process the following NDP frame and prepare for beamforming feedback. The Feedback type filed 1804 may specify the type of feedback requested. The requested feedback may be single user MIMO oriented feedback, or multiple user MIMO oriented feedback. The Nc index 1806 may specify the rank order requested for the feedback. The Role of AP1 field 1808 and Role of AP2 field 1810 may indicate the role of AP1 and AP2, respectively. For example, the fields may indicate whether the AP is a serving AP or an interfering AP.

With sounding packets transmitted from the transmitters, the receiving STAs may process the sounding packets, perform channel estimations, and prepare spatial beamforming reports to enable SCMA transmissions. For each STA, the beamforming report may take a format as illustrated in FIG. 19. The beamforming report 1900 may include a Category field 1902 that may be set to VHT. The VHT action field 1904 may be set to VHT compressed beamforming or any other new action. This may differentiate the beamforming report 1900 from other action frames. The VHT MIMO control fields 1906, 1912 may have the format shown in FIG. 20. The VHT beamforming report fields 1908, 1914 may comprise the actual beamforming report for the associated AP (specified in the VHT MIMO control field). Different feedback schemes may be used, e.g., a compressed beamforming report based on Givens rotation decomposition or others. The MU exclusive beamforming report fields 1910, 1916 may be needed if MU-MIMO operation is desired, and may be used to provide extra information regarding the underlying channels. The fields of the beamforming report my comprise reports for multiple APs, for example, a report 1918 for AP1 and a report 1920 for AP2.

The beamforming report 1900 may be transmitted in an omni-directional manner, such that it may be received by AP1 and AP2 directly. As used herein, an omni transmission pattern is a pattern in which signals are transmitted uniformly in all directions. This would remove the need for relaying channel information from one AP to another AP. Alternatively, the beamforming report 1900 may be transmitted in a beamformed manner such that only AP1 may receive the beamforming report. In such a case, it may be necessary for AP1 to relay channel state information to AP2 (and vice versa).

In the above, the VHT MIMO control fields 1906, 1912 may take a form as illustrated in FIG. 20. Referring to FIG. 20, the VHT MIMO control field 2000 may comprise an Nc index field 2002 that indicates a number of columns for the matrix to be reported in this frame. The Nr index field 2004 may indicate a number of rows for the matrix to be reported in this frame. The Channel width field 2006 may indicate the channel width in which the measurement to create the compressed beamforming matrix was made. The Grouping field 2008 may indicate the subcarrier grouping. The Codebook info field 2010 may indicate the size of codebook entries. The Feedback type field 2012 may indicate the feedback type, for SU-MIMO or for MU-MIMO. The Remaining segments field 2014 may indicate the number of remaining segments for the associated frame. The First segment field 2016 may be set to 1 for the first segment of a segmented frame or the only segment of an unsegmented frame, and set to 0 otherwise. The AP index field 2018 may indicate the intended recipient AP of the associated beamforming report. The Desired/undesired field 2020 may indicate whether the AP indicated in the AP index field 2018 is the serving AP (for which the beamforming report corresponds to the desired beam) or the interfering AP (for which the beamforming report corresponds to the undesired beam). Such a bit may not be included, but may be helpful if it is included. The SSN field 2022 may indicate the sequence number from the NDPA frame soliciting feedback.

Feedback procedures may need to support polling based feedback and non-polling based feedback. In a variation of the above procedure, a STA may feed back the maximum interference expected from an undesired AP. The undesired AP may use this value as a design parameter in the generation of the precoder to its desired user. This may be placed in an additional field in the VHT MIMO control field 2000.

The following embodiment provides an open loop procedure for SCMA. With open loop SCMA, the APs may not transmit sounding frames, and may not require channel state information feedback from the STAs. Instead, the APs may assume channel reciprocity and estimate channel state information from frames transmitted from STAs to APs. In this way, the overhead due to sounding and feedback may be saved. However, in order to achieve good PHY layer performance, antenna calibration may be needed.

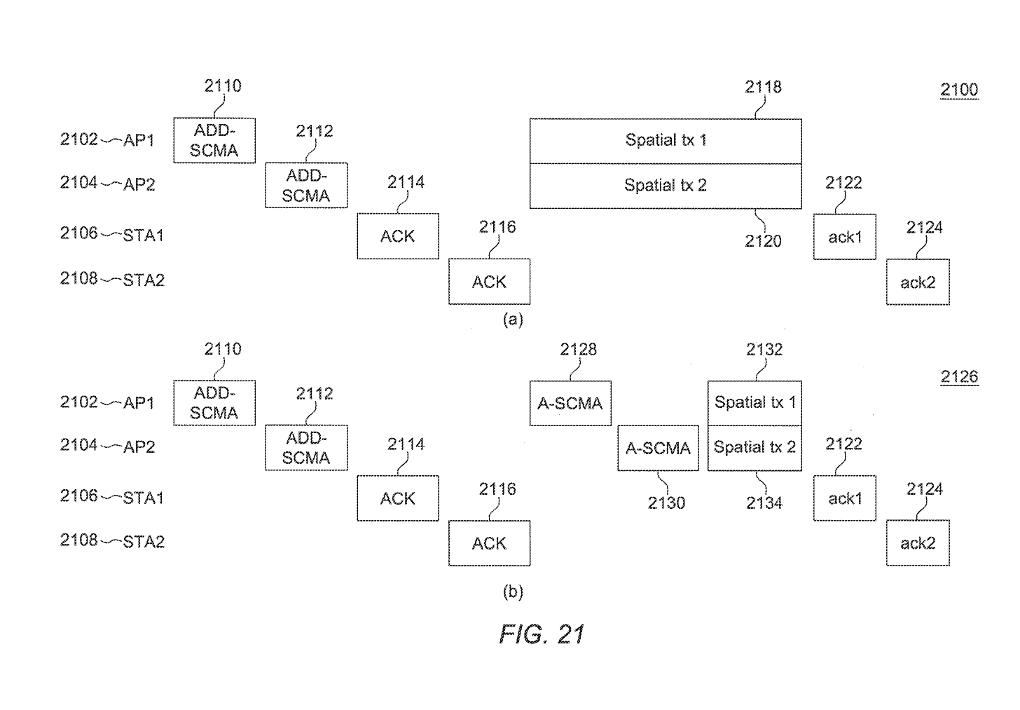

FIG. 21 shows two examples of sequence exchanges to set up an SCMA transmission with synchronized data/ACK transmission. In the first procedure 2100, AP1 2102 may sense and acquire the media. AP1 2102 may begin a transmission opportunity (TXOP) by sending an ADD-SCMA frame 2110. The ADD-SCMA frame 2110 may include an SCMA group ID which may indicate that AP1 2102, AP2 2104, STA1 2106, and STA2 2108 in this example form an SCMA group.

On receiving the ADD-SCMA frame 2110, AP2 2104 may send an ADD-SCMA frame 2112 that repeats the ADD-SCMA frame 2110 again. On receiving the ADD-SCMA frames 2110, 2112, the unintended STAs may set their network allocation vectors (NAVs) accordingly. After receiving the ADD-SCMA frame 2110 transmitted from AP1 2102, STA1 2106 may know that it is in the SCMA group. By checking the group position, STA1 2106 may know that it may reply with an ACK 2114 immediately after both AP1 2102 and AP2 2104 have transmitted the ADD-SCMA frames 2110, 2112.

After receiving the ADD-SCMA frame 2110 transmitted from AP1 2102, STA2 2108 may know that it is in the SCMA group. By checking the group position, STA2 2108 may know that it may reply with an ACK 2116 after the ACK 2114 transmitted by STA1 2106. The ACKs 2114, 2116 transmitted by STA1 2106 and STA2 2108 may contain a full set of LTFs, i.e., the number of LTFs may be equal to the number of antennas of STA1 2106 and STA2 2108. This may allow AP1 2102 and AP2 2104 to estimate the full dimension of the channel from the uplink ACKs 2114, 2116. Both AP1 2102 and AP2 2104 may estimate channel state information from the ACK 2114 transmitted by STA1 2106 and the ACK 2116 transmitted by STA2 2108.

AP1 2102 may collect the channel state information from both STA1 2106 and STA2 2108. According to the SCMA group ID, AP1 2102 may know that it may transmit a data packet to STA1 2106, and at the same time AP2 2104 may transmit a separate data packet to STA2 2108. AP1 2102 may carefully choose a spatial weight according to the estimated channel state information. The criteria of choosing the weight may be to strengthen the desired link and at the same time suppress the interference link. The design of the weight is an implementation issue and may be determined as desired. AP2 2104 may calculate the weight in the same way as AP1 2102.

After the initial sequence exchange to set up the SCMA process, the APs 2102, 2104 may follow the procedure 2100 and begin data transmissions 2118, 2120 immediately. Alternatively, the APs may follow the procedure 2126 shown in FIG. 19(b), and transmit announcement frames A-SCMA 2128, 2130. The A-SCMA frames 2128, 2130 may be used to confirm and announce the following SCMA transmission 2132, 2134.

The A-SCMA frames 2128, 2130 may be transmitted with an omni-directional antenna pattern. The APs 2102, 2104 may choose to transmit the A-SCMA frames 2128, 2130 one after another sequentially. Alternatively, the APs may transmit the A-SCMA packets simultaneously (not shown in the Figure). When simultaneous transmission of A-SCMA frames is utilized, the A-SCMA frames may be identical for both APs. In this case, the MAC header design of the A-SCMA frame may follow the format described above and shown in FIG. 17 for sounding packets.

The A-SCMA frame may also be transmitted with selected SCMA weights, i.e., the same weights used to transmit the SCMA data session. Similar to omni-directional transmissions, both sequential transmission and simultaneous transmission may be possible in this scenario.

After the SCMA data transmission, both STAs 2106, 2108 may send an ACK 2122, 2124 back to the APs 2102, 2104 to indicate whether the packet is received error free. The ACKs 2122, 2124 may be transmitted after the completion of the data transmission session. If the durations of the data sessions are not equal, e.g., spatial transmission 1 is longer than spatial transmission 2, the ACKs 2122, 2124 may be transmitted after the completion of the longer spatial stream, i.e., spatial transmission 1. Alternatively, the APs 2102, 2104 may coordinate and pad null bits/symbols to make the spatial streams be of equal duration. The ACKs 2122, 2124 may be transmitted sequentially as shown in FIG. 21. The order to transmit ACKs may be defined in the User Position Field of the SCMA Group ID.

Another choice is to transmit parallel ACKs from both STA1 2106 and STA2 2108 simultaneously. With this choice, the STAs 2106, 2108 may have multi-antenna capabilities. Moreover, the STAs 2106, 2108 may monitor the channels from both APs 2102, 2104 during the sequence exchange period before the data transmission. In this way, the STAs 2106, 2108 may train a set of weights which may enhance the desired signal and suppress the interference signal.

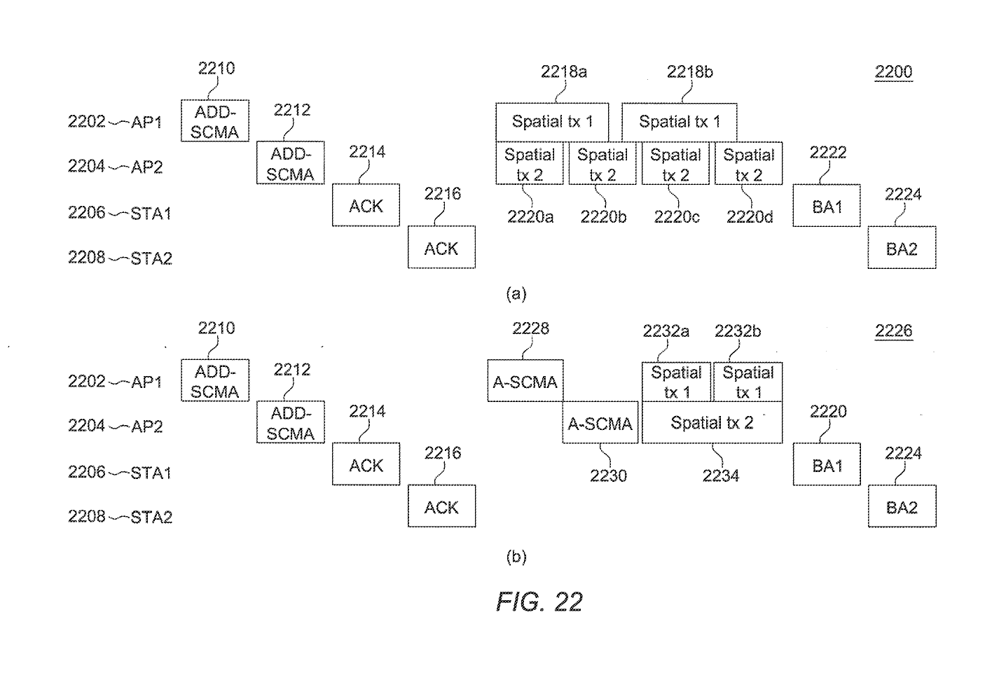

The two examples of open loop SCMA shown in FIG. 21 depict synchronized data/ACK transmission. Synchronized data/ACK transmission means that the two spatial streams transmitted from AP1 and AP2 are synchronized. However, it is also possible that AP1 and AP2 may transmit without synchronization (as shown in FIG. 22). Like numbers in FIGS. 21 and 22 correspond to like elements. For example, 2102 in FIGS. 21 and 2202 in FIG. 2 both refer to AP1. In FIG. 22(a), however, the transmissions 2218, 2220 may be unsynchronized, and may be broken up into shorter transmission 2218a, 2218b, 2220a-c. The same may be true for the transmissions 2232, 2234 shown in FIG. 22(b). The unsynchronized transmission scheme may work with block ACK transmissions 2222, 2224. The ADD-SCMA frames 2210, 2212 may contain information which is normally defined in an add block acknowledgement (ADDBA) frame, e.g., a block ACK policy, a traffic ID (TID), a buffer size, and a block ACK timeout value, etc. The ACK frames 2214, 2216 transmitted by the STAs 2206, 2208 may be modified to contain corresponding information as well.

The figures and examples presented in this embodiment involve two APs and two STAs for SCMA transmission. However, the schemes and mechanisms may be easily extended to multiple APs with multiple STAs.

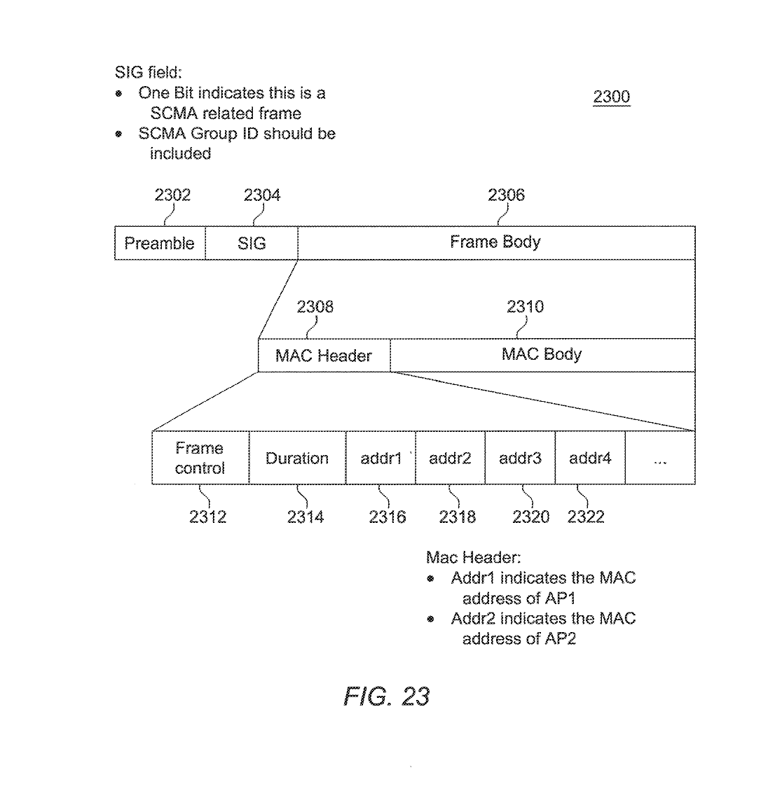

In FIG. 23, an example of a frame format 2300 defined for SCMA related transmission is given. This frame format may be used by SCMA related transmissions, for example, NDPA frames, NDP frames, and feedback frames shown in FIG. 16, and ADD-SCMA frames, A-SCMA frames, and ACK frames shown in FIGS. 21 and 22. The SCMA data frames may use this frame format as well.

The frame 2300 may comprise a Preamble field 2302, a signal (SIG) field 2304, and a frame body 2306. The frame body 2306 may comprise a MAC header 2308 and a MAC body 2310. The MAC header may include a Frame control field 2312, a Duration field 2314, and four address fields 2316-2322. In this example, one bit may be added to the SIG field 2304 which may indicate that the frame is an SCMA frame. An SCMA group ID may be included in the SIG field 2304 as well. Depending on the definition of the SCMA group ID, the four address fields 2316-2322 in the MAC header 2308 may be redefined to identify the two or more involved APs.

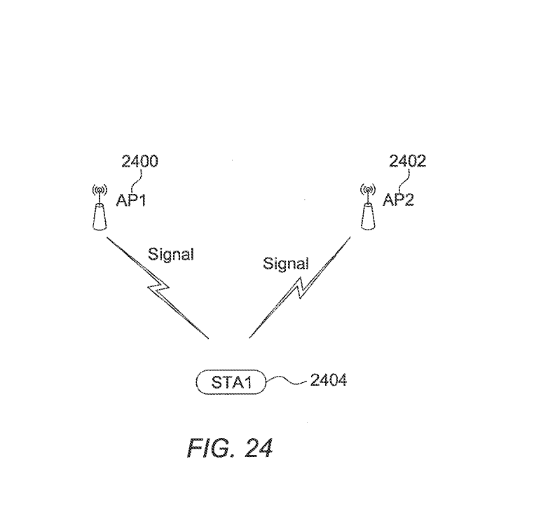

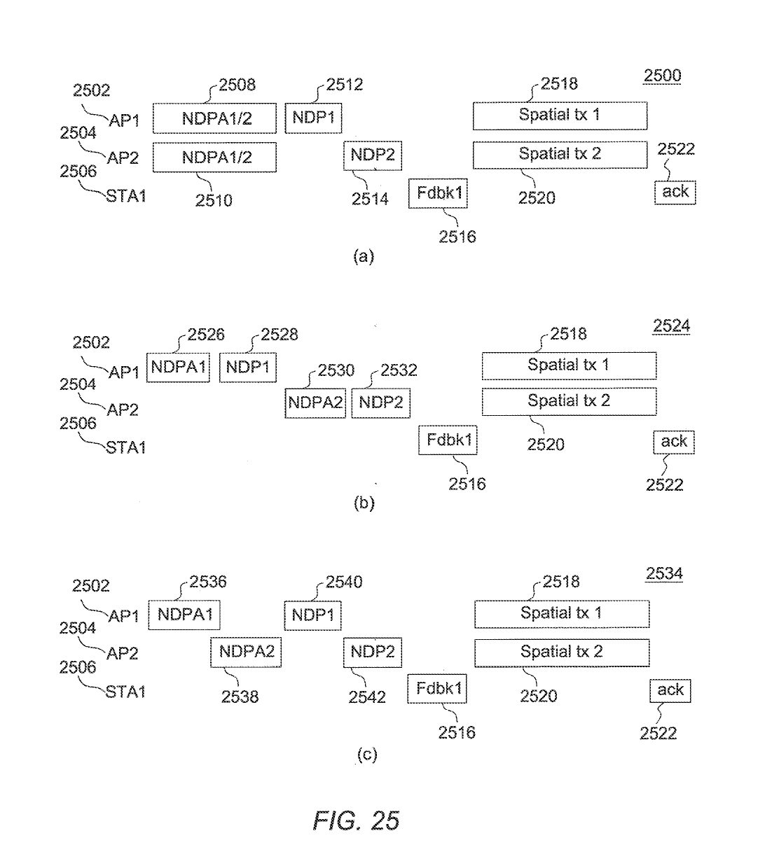

Like SCMA, joint precoded multi-AP (JPMA) downlink allows multiple APs to transmit simultaneously. For JPMA, two or more AP's may transmit to a single STA at the same time. Consider the example as illustrated in FIG. 24, wherein both AP1 2400 and AP2 2402 desire to transmit to the same STA 2404. The signaling procedure described herein and depicted in FIG. 25 may enable JPMA as illustrated in the FIG. 24.

In the procedure 2500 shown in FIG. 25(a), AP1 2502 and AP2 2504 may send out NDPA frames 2508, 2510. The NDPA frames 2508, 2510 may have the format shown in FIG. 17. The NDPA frames 2508, 2510 may announce that NDP frames 2512, 2514 from AP1 2502 and AP2 2504 may follow. This may help the intended STA1 2506 prepare for channel estimation and feedback.

AP1 2502 may send out the NDP1 frame 2512. STA1 2506 may use the NDP1 frame 2512 to estimate the wireless channel between AP1 2502 and STA1 2506. AP2 2504 may send out the NDP2 frame 2514. STA1 2506 may use the NDP2 frame 2514 to estimate the wireless channel between AP2 2504 and STA1 2506. STA1 2506 may send back feedback 2516. AP1 2502 and AP2 2504 may compute the transmit beamforming vectors and may start actual data transmissions 2518, 2520 at the same time. STA1 2506 may send an ACK message 2522.

In the above procedure 2500, the NDPA frames 2508, 2510 from AP1 and AP2 may be transmitted at the same time, possibly using CSD as described above. In this case, both NDPA frames 2508, 2510 may be identical. It is noted that backhaul communications between AP1 2502 and AP2 2504 may be needed here such that the same NDPA frames 2508, 2510 may be prepared at AP1 2502 and AP2 2504 and transmitted at the same time.

A slight variation of procedure 2500 is shown in FIG. 25(b). In procedure 2524, the NDPA1 2526 and NDP1 2528 from AP1 2502 may be transmitted together, followed by NDPA2 2530 and NDP2 2532 from AP2 2504.

Another slight variation of the above procedures 2500, 2524 is shown in FIG. 23(c). In procedure 2534, NDPA1 2536 from AP1 2502 and NDPA2 2538 from AP2 2504 may be transmitted one after another. These may be followed by NDP1 2540 from AP1 2502 and NDP2 2542 from AP2 2504, which may also be transmitted one after another.

For JPMA, the sounding frame may be similar to that described above and shown in FIGS. 17 and 18 for SCMA sounding. The feedback frame may be similar to that described above and shown in FIGS. 19 and 20 for SCMA feedback.

The following embodiment addresses open loop solutions to enable JPMA transmission. With open loop JPMA, the APs may not transmit sounding frames, and may require channel state information feedback from the STA. With open loop transmission, two technologies may be applied to JPMA: open loop beamforming and an open loop MIMO scheme. In open loop beamforming, the APs may assume channel reciprocity and may estimate channel state information from frames transmitted from the STA to the APs. In an open loop MIMO scheme, the APs may not need the channel state information, and JPMA may be performed without prior channel information. For example, the JPMA may consider utilizing open loop MIMO schemes, such as space-time block codes (STBC), space-frequency block codes (SFBC), CSD, etc.

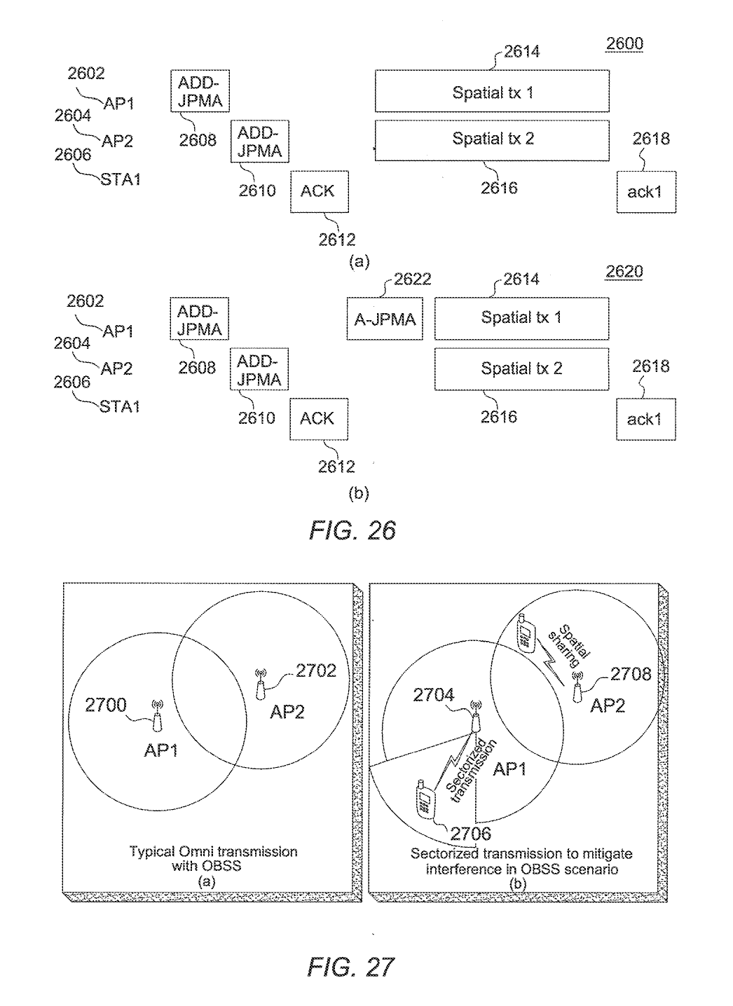

FIG. 26 shows two examples of sequence exchanges used to set up a JPMA transmission. In the procedure 2600, AP1 2602 may sense and acquire the media. AP1 2602 may begin a TXOP by sending an ADD-JPMA frame 2608. The ADD-JPMA frame 2608 may include a JPMA group ID, which may indicate that AP1 2602, AP2 2604, and STA1 2606 in this example form a JPMA group.

On receiving the ADD-JPMA frame 2608, AP2 2604 may send the ADD-JPMA frame 2610, repeating the ADD-JPMA frame 2608 again. On receiving the ADD-JPMA frames 2608, 2610, the unintended STAs may set their NAVs accordingly. After receiving the ADD-JPMA frame 2608 transmitted from AP1 2602, STA1 2606 may know that it is in the JPMA group. By checking the group position, STA1 2606 may know that it may reply with an ACK 2612 immediately after both AP1 2602 and AP2 2604 have transmitted the ADD-JPMA frames 2608, 2610.

With an open loop beamforming scheme, both AP1 2602 and AP2 2604 may estimate channel state information from the ACK 2612 transmitted by STA1 2606. The ACK 2612 transmitted from STA1 2606 may contain a full set of LTFs, i.e., the number of LTFs may equal the number of antennas of STA1 2606. This may allow AP1 2602 and AP2 2604 to estimate the full dimension of the channel from the uplink ACK 2612. Channel estimation may not be needed if an open loop MIMO scheme is used.

After the initial sequence exchange to set up the JPMA process, the APs 2602, 2604 may begin data transmissions 2614, 2616 immediately. Alternatively, the APs 2602, 2604 may transmit announcement frame(s) A-JPMA 2622, as shown in procedure 2620 in FIG. 26(b). An A-JPMA frame may confirm and announce the following JPMA transmission. It is possible that one of the APs 2602, 2604 (according to the user position defined in the JPMA group ID) may transmit the A-JPMA frame 2622 as shown in FIG. 26(b). It is also possible that the APs transmit A-JPMA frames simultaneously, or one after another sequentially. The A-JPMA frame 2622 may be transmitted with an omni antenna pattern or beamformed antenna pattern. After the JPMA data transmissions 2614, 2616, STA1 2606 may send an ACK 2618 back to the APs 2602, 2604.

The following embodiment considers sectorized transmissions, and may be combined with any of the previous embodiments to allow an AP to communicate with a STA in a first sector without interfering with STAs in other sectors. This may be particularly important when multiple AP transmit to multiple STAs at the same time, as shown in FIG. 15. With a dense deployment, the chance of having overlapping BSSs, or co-channel BSSs, may be high. As a result, the users in one BSS may experience excessive interference from a co-channel BSS, which may be an AP device or one or more non-AP STA devices. As shown in FIG. 27(a), AP1 2700 and AP2 2702 form two co-channel BSSs which have an overlapping coverage area. Using a legacy omni antenna pattern transmission, the devices located in the overlapping area may be able to communicate with both AP1 2700 and AP2 2702. In addition, if AP1 2700 and AP2 2702 are out of reception range of each other, there may be a hidden node problem. In the existing IEEE 802.11 specification, request-to-send and clear-to-send packets (RTS/CTS) may be used to solve the hidden node issue. However, this may prevent AP1 2700 and AP2 2702 from transmitting simultaneously, and thus may reduce the spectral efficiency. FIG. 27b gives an example of sectorized transmission. AP1 2704 is communicating with one of its associated STAs 2706 using sectorized transmission. When AP1 2704 utilizes sectorized transmission with a STA in the sector, AP1 2704 may transmit and receive using a sectorized antenna mode/pattern. As a result, AP1 2704 may not interfere with AP2 2708, the co-channel BSS AP at both the transmitting and receiving side. The STA 2706 may transmit and receive using an omni antenna pattern or another possible antenna pattern depending on the implementation.

In order to perform sectorized transmission, the AP may need to know the best sector for each associated STA. This embodiment describes procedures that may be implemented at the STA to support sectorized transmissions. The embodiment includes methods for beacon transmissions using sectorized transmission intervals, and methods which allow the AP/STA communication procedures to be optimized for the non-AP STA.

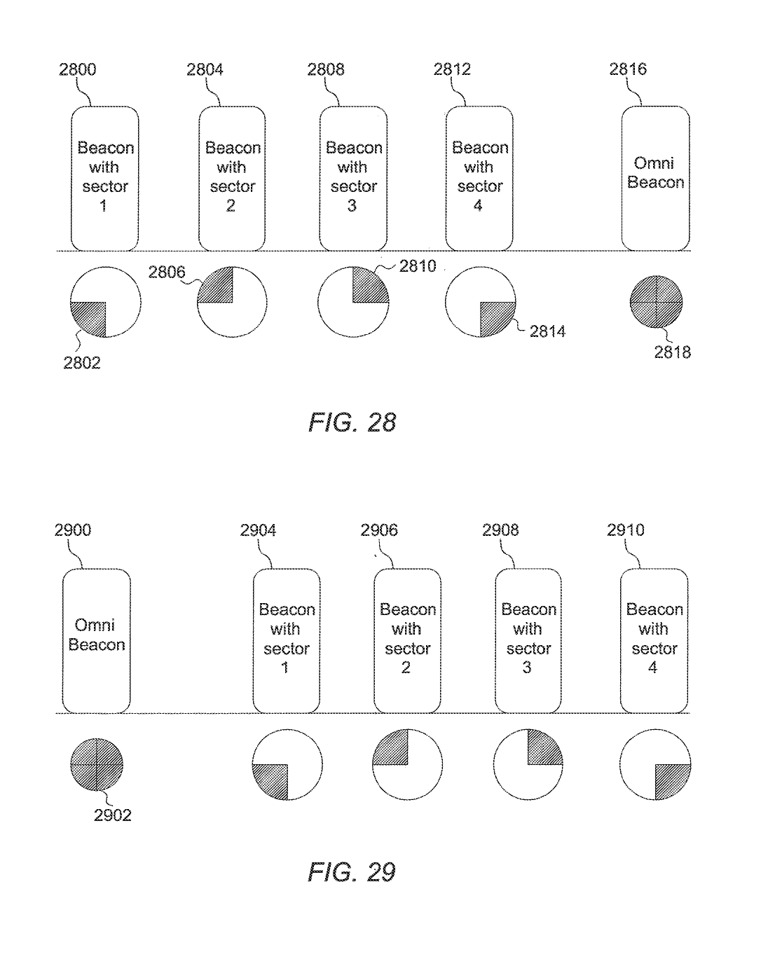

As shown in FIG. 28, the beacon may be transmitted with a sectorized or beamformed antenna pattern. In this example, the first beacon 2800 may be transmitted with beam/sector 1. Without loss of generality, the coverage area of beam sector 1 may be illustrated as being a quarter 2802 of the omni coverage 2818. With sectorized transmission, the coverage range may be extended relative to that obtained with use of the legacy omni antenna pattern. The second, third, and fourth beacons 2804, 2808, 2812 may be transmitted with other sector beams with coverage areas of other quarters 2806, 2810, 2814 of the omni coverage 2818. The last beacon 2816 in the example below may be transmitted using an omni antenna pattern 2818. The number of beacons and location/division of the sectors in this embodiment is purely exemplary, and is not meant to be limiting.

Alternatively, as shown in FIG. 29, it may be possible for the AP to initially transmit a beacon using an omni antenna pattern 2902, followed by one or more directional or sectored beacons 2904-2910. Information pertaining to the use of directional beacons (e.g. how many directional beacons to follow, the interval between the directional beacons, etc.) may be included in the transmission of the initial omni beacon 2900.

The AP may also use the sectorized transmissions and omni transmission to divide users. A STA may associate with either the omni transmission or one of the sectorized transmissions. The AP may include a set of association identifiers (AIDs) which are associated with the STAs transmitting in the particular antenna pattern.

With sectorized beacon transmissions, sectorized beam training may be part of the beacon transmission. When a sectorized beacon is transmitted, the AP may include the sector identifier (ID) identifying the sector that the AP is currently transmitting to, the total number of sectorized beam patterns used, the expected time instant for the next omni beacon transmission, and the period of the sectorized beacon transmission.

STAs which try to associate with the AP may detect the sector ID and other information included in the sectorized beacon, and may perform normal association and authentication. When a STA hears the sectorized beacon, it may choose the current sector, or it may wait for the sector with the best received signal strength. The STA may include the preferred sector ID in an uplink packet.

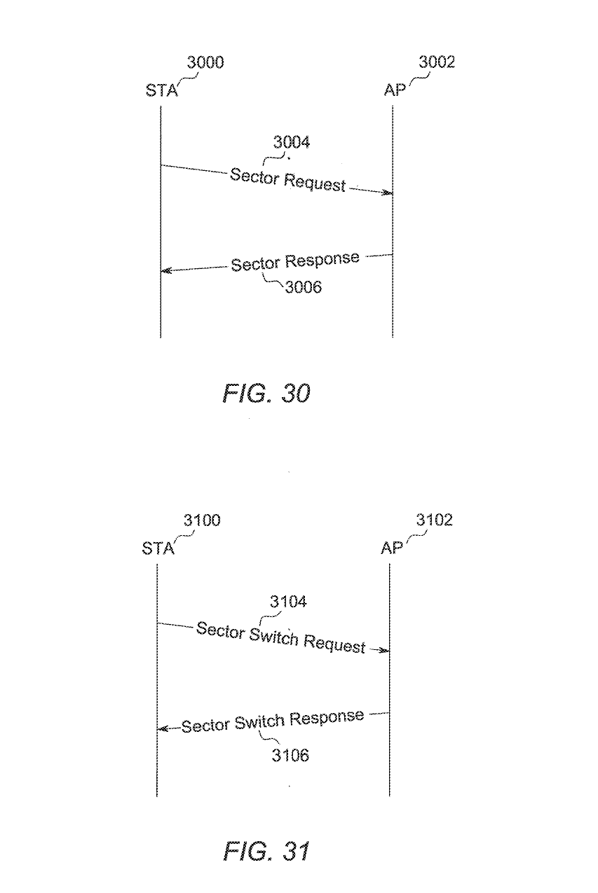

It may also be possible for an AP and a STA to set up sectorized transmission through a series of handshakes. FIG. 30 shows an example of a sectorized transmission setup protocol. The STA 3000 may send a sector request frame 3004 to the AP 3002 and may indicate the sector that it intends to work with. Alternatively, the STA 3000 may include a list of sectors which may be ordered by the received signal power or received signal strength indicator (RSSI). The AP 3002 may then transmit a sector response frame 3006 back to the STA 3000 to indicate the sector that the AP 3002 has assigned to the STA 3000. The sector that the AP 3002 assigns to the STA 3000 may not be the sector that the STA 3000 requested.

STAs which have associated with the AP may switch from omni transmission to sectorized transmission, switch from sectorized transmission to omni transmission, or switch between sectors according to the received beacon strength. The STAs may include a sector ID in their uplink frames to inform the AP of the preferred sector. Alternatively, the STAs may negotiate with the AP using sector switch protocols. FIG. 31 shows an example of a sector switch protocol. The STA 3100 may send a sector switch request frame 3104 to the AP 3102 indicating the sector that it intends to switch to. Alternatively, the STA 3100 may include a list of sectors which may be ordered by the received signal power or RSSI. The AP 3102 may then transmit a sector switch response frame 3106 back to the STA 3100 indicating the sector that the AP 3102 has assigned to the STA 3100. The sector that the AP 3102 assigns to the STA 3100 may or may not be the sector the STA 3100 requested.

When transmitting a sectorized beacon, the AP may determine and announce a sectorized beacon interval. Within the sectorized beacon interval, the AP may use the same sectorized antenna pattern for reception. The AP may use the sectorized antenna pattern for all the transmissions, except that the AP may use an omni antenna pattern for protection frames. The sectorized transmit antenna pattern and sectorized receive antenna pattern may have the same coverage area. The sectorized transmission antenna pattern may be the same as the antenna pattern used for the sectorized beacon transmission.

The STAs associated with the sectorized beacon may monitor and detect all the beacons when possible, and conduct transmission only on the associated/assigned sectorized beacon interval. Alternatively, the STAs may check the associated sectorized beacon and remember the time for the next beacon with the same sectorized antenna pattern. The STAs may stay awake during the associated beacon interval, and enter a power saving mode during other beacon intervals and wake up before the next associated beacon interval. The STAs may transmit with an omni antenna pattern or using beamforming schemes depending on the implementation.

Another possible sectorized transmission is proposed herein. The beacon and entire beacon interval may not be necessarily sectorized. Instead, the procedure used by the AP and associated STA(s) may switch between a sectorized transmission and an omni transmission mode.

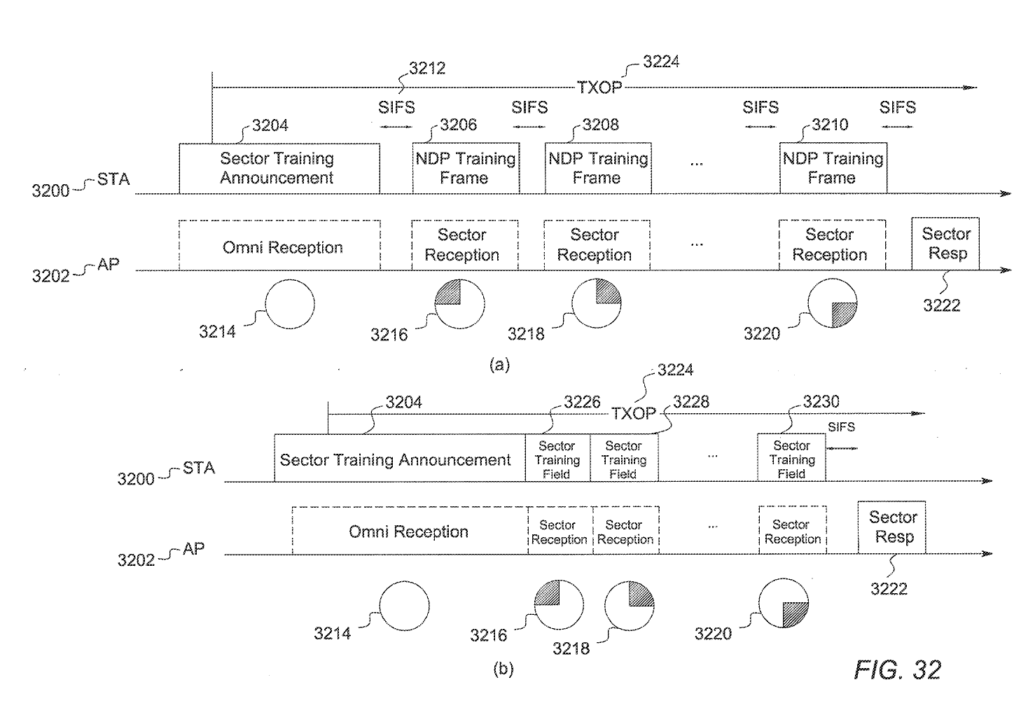

The sectorized beam training and feedback may utilize implicit mechanisms or explicit mechanisms. Implicit sectorized beam training may assume channel reciprocity, i.e., that the best receive sector from a certain STA is also the best sector for transmission to the same STA. Two examples of implicit sectorized beam training and feedback mechanism are given in FIG. 32. The example shown in FIG. 32(a) illustrates the detailed implicit sectorized beam training procedure.

The STA 3200 may transmit a Sector Training Announcement frame 3204 to the AP 3202. This frame may announce the number of null data packet (NDP) Training frames 3206-3210 following the Sector Training Announcement frame 3204. The frame may set up a TXOP 3224 until the end of the implicit sectorized beam training procedure. The AP 3202 may use an omni antenna pattern 3212 to receive the frame 3204.

NDP Training frames 3206-3210 may be repeated and transmitted following the Sector Training Announcement frame 3204. The Sector Training Announcement frame 3204 may be separated from the first NDP Training frame 3206 by a short interframe space (SIFS) 3212 or other duration. The Training frames 3206-3210 may also be separated by a SIFS or other duration. The Training frames 3206-3210 may not contain any MAC layer information and may include STF, LTF and SIG fields. The SIG field may be overwritten to indicate a sector ID and a countdown number. The countdown number may indicate how many NDP Training frames remain. The NDP Training frames may be transmitted by the STA 3200 using an omni antenna pattern. The AP 3202 may switch the receiving antenna sector pattern 3214-3220 to find out which sector is the best for the STA 3200.

After all of the NDP Training frames 3206-3210 have been transmitted, the AP 3202 may send a Sector Response frame 3222 to the STA 3200 assigning a sector. Alternatively, the AP 3202 may not send a Sector Response frame 3222 to the STA 3200.

The scheme shown in FIG. 32(b) is similar to that shown in FIG. 32(a). There is no SIFS, however, between the Sector Training Announcement frame 3204 and the following Sector Training fields 3226-3230 used for sector beam training. The Sector Training fields may contain a STF, a LTF, or both.

Note that the scheme shown in FIG. 32 is a general scheme which works for all types of antenna realizations. For example, with sectorized antennas the number of NDP Training frames or Sector Training fields may be the same as the number of sectorized antennas. With an antenna array, the number of NDP Training frames or Sector Training Field may be the same as the number of transmit beam directions. Then the AP may select the best sector for the STA according to the uplink channel.

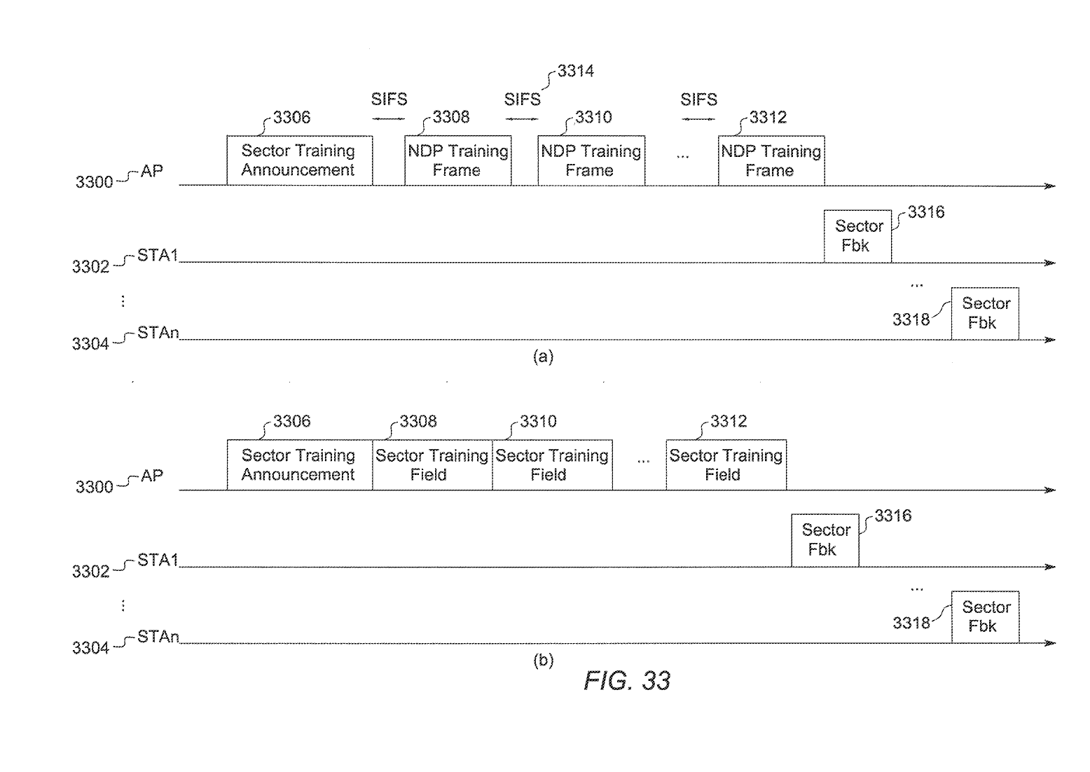

In contrast to implicit sectorized beam training, explicit sectorized beam training may not assume channel reciprocity, and feedback from the STAs may be used to support sector/beam training. Two examples of explicit sectorized beam training and a feedback mechanism are given in FIG. 33. The example shown in FIG. 33(a) illustrates the detailed explicit sectorized beam training procedure.

The AP 3300 may multi-cast or broadcast a Sector Training Announcement frame 3306. This frame may announce the number of NDP Training frames 3308-3312 following the Sector Training Announcement frame 3306. The frame 3306 may set up a TXOP until the end of the explicit sectorized beam training procedure. The AP 3300 may use an omni antenna pattern to transmit the frame 3306. In order to send this frame to most of the users which may be covered by the sectorized transmission, the AP 3300 may use the lowest modulation and coding schemes. If necessary, the AP 3300 may even use lower data rate schemes, such as repetition schemes.

Following the transmission of Sector Training Announcement frame 3306, the AP may transmit multiple NDP Training frames 3308-3312. The NDP Training frames may be separated by a SIFS 3314 or similar duration and transmitted using different sectorized antenna patterns. The Training Frame may not contain any MAC information and may include STF, LTF and SIG fields. It is noted that a separate STF is needed for each sector, such that the AGC setting may be set properly for different sectors. The SIG field may be overwritten, or overloaded, to indicate the sector ID, and may include a countdown number. The countdown number may indicate how many NDP Training frames are left for transmission.

The STAs 3302, 3304 which intend to enroll with sectorized transmissions or change sectors may send Sector Feedback frames 3316, 3318 to the AP. For example, the Sector feedback frames 3316, 3318 may be transmitted with a poll-transmission format, i.e., the AP may poll a STA, and the polled STA may send the Sector Feedback frame. STAs may also piggyback the Sector Feedback frame with a normal data frame, control frame, or management frame. Another choice may be to transmit the Sector Feedback frame as normal frame, i.e., the STA may acquire the medium and transmit the frame.

Note that a SIFS is used as inter-frame space between training frames and feedbacks in the examples shown in FIG. 32(a) and FIG. 33(a). However, it is possible for the specifications to define a new inter-frame spacing or reuse other possible inter-frame spaces. Alternatively, the inter-frame spacing may be eliminated, as shown in FIGS. 32(b) and 33(b).

The apparatus shown in FIGS. 1B and 1C may be configured to perform the steps described above and shown in FIGS. 32 and 33. Specifically, the APs 160a, 160b, 160c may include a processor, a receiver, and a transmitter configured to perform the methods described above. The STAs 170a, 170b, 170c in FIG. 1C may also include a processor, a receiver, and a transmitter configured to perform the methods described herein. The APs 160a, 160b, 160c and/or STAs 170a, 170b, 170c may include multiple antennas for sectorized transmission and reception.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

### Embodiments

1. A method for use in an access point (AP), the method comprising:

enabling multi access point (multi-AP) transmissions.

2. The method of embodiment 1, further comprising:

coordinating multi-AP transmissions.

3. The method of embodiment 1, further comprising:

controlling multi-AP transmissions.

4. The method as in any of the preceding embodiments, wherein the control of the multi-AP transmissions is from a central wireless local area network (WLAN) controller.

5. The method as in any of the preceding embodiments, wherein the coordination of the multi-AP transmissions is from a central WLAN controller.

6. The method as in any of the preceding embodiments, wherein Cyclic Shift Diversity (CSD) is applied to short training fields (STF) transmitted from multiple APs using a WLAN Controller.

7. The method as in any of the preceding embodiments, wherein different cyclic phase delays are applied for each AP to transmit the STF.

8. The method as in any of the preceding embodiments, wherein different CSD are applied across a plurality of transmit antennas employed at the AP.

9. The method as in any of the preceding embodiments, further comprising:

estimating channel delay spread between a first AP and a station (STA);

estimating channel delay spread between a second AP and STA;

feeding back the delay spread for the first and second AP; and

adjusting the delay spread based on the feedback.

10. The method as in any of the preceding embodiments, further comprising:

estimating channel delay spread between a first AP and STA;

estimating channel delay spread between a second AP and STA;

selecting a cyclic shift based on the channel delay;

sending the cyclic shift from the first AP to a second AP; and

receiving the cyclic shift at the second AP and adjusting cyclic shift at the second AP.

11. The method as in any of the preceding embodiments, wherein long training fields (LTF) are used to perform channel estimation.

12. The method as in any of the preceding embodiments, wherein LTFs are assigned an index associated with a particular AP.

13. The method as in any of the preceding embodiments, wherein adaptive CSD values are associated with the LTF index.

14. The method as in any of the preceding embodiments, wherein multiple orthogonal STF sequences are transmitted from each AP.

15. The method as in any of the preceding embodiments, wherein code division multiplexing (CDM) is used to transmit orthogonal STFs from more than one AP.

16. The method as in any of the preceding embodiments, wherein time division duplex (TDD) is used to transmit orthogonal STFs from more than one AP.

17. The method as in any of the preceding embodiments, wherein frequency division duplex (FDD) is used to transmit orthogonal STFs from more than one AP.

18. The method as in any of the preceding embodiments, wherein code division multiplexing (CDM) is used to transmit orthogonal STFs from more than one AP.

19. The method as in any of the preceding embodiments, wherein cross correlation is applied to find correlation with each STF sequence.

20. The method as in any of the preceding embodiments, wherein multiple orthogonal LTF sequences are transmitted from each AP.

21. The method as in any of the preceding embodiments, wherein code division multiplexing (CDM) is used to transmit orthogonal LTFs from more than one AP.

22. The method as in any of the preceding embodiments, wherein time division duplex (TDD) is used to transmit orthogonal LTFs from more than one AP.

23. The method as in any of the preceding embodiments, wherein frequency division duplex (FDD) is used to transmit orthogonal LTFs from more than one AP.

24. The method as in any of the preceding embodiments, wherein code division multiplexing (CDM) is used to transmit orthogonal LTFs from more than one AP.

25. The method as in any of the preceding embodiments, wherein cross correlation is applied to find correlation with each LTF sequence.

26. The method as in any of the preceding embodiments, wherein a data packet is transmitted from multiple APs using a WLAN controller.

27. The method as in any of the preceding embodiments, wherein CSD is applied on the data packet transmitted from multiple APs.

28. The method as in any of the preceding embodiments, wherein the STA selects the transmission from the AP with the strongest signal.

29. The method as in any of the preceding embodiments, wherein the STA coherently combines the signals from multiple APs.

30. The method as in any of the preceding embodiments, wherein different encoded copies of the same data are transmitted from multiple APs.

31. The method as in any of the preceding embodiments, wherein Space Time Block Codes (STBC) are applied across multiple APs.

32. The method as in any of the preceding embodiments, wherein bit/symbol interleaving is performed across multiple APs using a WLAN controller.

33. The method as in any of the preceding embodiments, wherein a single forward error correction encoder (FEC) is used to encode data to be distributed to multiple APs.

34. The method as in any of the preceding embodiments, further comprising:

dividing the encoded bit stream into multiple blocks;

delivering the bit streams to an interleaver;

reshuffling by the interleaver the incoming bit streams into multiple output bit streams;

modulating a first bit stream output from the interleaver transmitting from a primary access point (AP); and

modulating a second bit stream output from the interleaver and then transmitting from one or more non-primary APs.

35. The method as in any of the preceding embodiments, further comprising:

decoding by the STA a capability indication from the primary AP or the WLAN controller;

performing separate equalization/demodulation for the first stream sent from a first AP and the second stream sent from a second AP;

dividing a first bit stream into multiple blocks and sending the first bit stream to a deinterleaver module;

dividing the second soft bit stream and sending the second bit stream to a deinterleaver module;

arranging by the deinterleaver module the two bit streams into one bit stream to restore the original ordering; and

sending the deinterleaved bit stream to a decoder for FEC decoding.

36. The method as in any of the preceding embodiments, wherein multiple FECs are used to encode data to be distributed to multiple APs.

37. The method as in any of the preceding embodiments, further comprising:

encoding an incoming bit stream at a first encoder;

encoding an incoming bit stream at a second encoder;

dividing the first encoded bit stream into multiple blocks;

dividing the second encoded bit stream into multiple blocks;

delivering the bit streams to the interleaver;

reshuffling by the interleaver the incoming bit streams into multiple output bit streams;

modulating the first bit stream output from the interleaver then transmitting from a primary AP; and

modulating the second bit stream output from the interleaver and then transmitting from one or more of the non-primary APs.

38. The method as in any of the preceding embodiments, further comprising:

performing separate equalization/demodulation for the first stream sent from a first AP and the second stream sent from a second AP;

dividing a first bit stream into multiple blocks and sending the first bit stream to a deinterleaver module;

dividing the second soft bit stream and sending the second bit stream to a deinterleaver module;

arranging by the deinterleaver module the two bit streams into one bit stream to restore the original ordering;

sending the first deinterleaved bit stream to a first decoder for FEC decoding; and

sending the second deinterleaved bit stream to a second decoder for FEC decoding.

39. The method as in any of the preceding embodiments, wherein the interleaving pattern of each AP is linked to its LTF index.

40. The method as in any of the preceding embodiments, further comprising:

assigning an LTF index to each transmit AP;

reading the LTF index for a first AP and the LTF index for a second AP; and

using the LTF indices to control the interleaver.

41. The method as in any of the preceding embodiments, wherein the multiple modulation and coding schemes (MCS) are used.

42. The method as in any of the preceding embodiments, wherein time domain feedback indicating a timing advance or timing retardation is used.

43. The method as in any of the preceding embodiments, wherein frequency domain feedback indicating a forward frequency rotation or backward frequency rotation is used.

44. The method as in any of the preceding embodiments, wherein multi-field feedback of either time domain or frequency domain feedback with a value indicating an amount of adjustment is used.

45. The method as in any of the preceding embodiments, wherein an AP performing the feedback sends back a timing/frequency adjustment ACK to the STAs.

46. The method as in any of the preceding embodiments, wherein two or more APs simultaneously transmit to more than one STA in a spatially coordinated multi-AP mode (SCMA).

47. The method as in any of the preceding embodiments, wherein sounding packets are transmitted in order to estimate downlink channel need and then feed back the estimate to a plurality of APs.

48. The method as in any of the preceding embodiments, wherein receiving STAs process sounding packets, perform channel estimation, and prepare beamforming reports.

49. The method as in any of the preceding embodiments, wherein an open loop procedure is used by APs wherein the APs assume channel reciprocity and estimate channel state information from frames transmitted from STAs.

50. The method as in any of the preceding embodiments, wherein joint precoded multi-AP (JPMA) is used wherein multiple APs transmit to one STA simultaneously.

51. The method as in any of the preceding embodiments, wherein a closed loop procedure for JPMA is used.

52. The method as in any of the preceding embodiments, wherein an open loop procedure for JPMA is used wherein APs do not transmit sounding frames and require channel state information feedback from STAs.

53. The method as in any of the preceding embodiments, wherein the AP in a multi-AP system communicates with STAs by utilizing sectorized transmission.

54. The method as in any of the preceding embodiments, wherein the AP in a multi-AP system communicates with STAs by utilizing sectorized transmission resulting in reduced interference.

55. The method as in any of the preceding embodiments, wherein the AP transmits and receives using a sectorized antenna mode/pattern.

56. The method as in any of the preceding embodiments, wherein the STA transmits and receives with an antenna pattern.

57. The method as in any of the preceding embodiments, wherein the STA transmits and receives with omni antenna pattern.

58. The method as in any of the preceding embodiments, wherein the coverage range is extended using sectorized transmission.

59. The method as in any of the preceding embodiments, wherein the AP transmits a Beacon using an omni antenna pattern followed by a plurality of sectored Beacons.

60. The method as in any of the preceding embodiments, wherein the AP uses sectorized transmission to divide users.

61. The method as in any of the preceding embodiments, wherein the AP includes a sector ID, a total number of sector beam patterns utilized, a time for the next expected omni beacon transmission, and a period of the sectorized beacon transmission for sectorized beam training and feedback.

62. The method as in any of the preceding embodiments, wherein the STA detects the sector ID, the total number of sector beam patterns utilized, the time for the next expected omni beacon transmission, and the period of the sectorized beacon transmission for sectorized beam training and feedback.

63. The method as in any of the preceding embodiments, wherein the STA includes the preferred sector ID in an uplink packet transmitted.

64. The method as in any of the preceding embodiments, wherein the AP assigns a sector to the STA through a handshake procedure.

65. The method as in any of the preceding embodiments, wherein the STA switches antenna mode/pattern based on the received beacon strength.

66. The method as in any of the preceding embodiments, wherein the STA negotiates assigned sector by utilizing a sector switch protocol.

67. The method as in any of the preceding embodiments, wherein the AP announces a sectorized beacon interval wherein the AP uses the same sectorized antenna pattern for reception during the sectorized beacon interval.

68. The method as in any of the preceding embodiments, wherein the STA transmits only on the associated sectorized beacon interval.

69. The method as in any of the preceding embodiments, wherein the STA stays alive during the sectorized beacon interval.

70. The method as in any of the preceding embodiments, wherein the STA enters power save mode during the sectorized beacon interval.

71. The method as in any of the preceding embodiments, wherein AP and STA switch between sectorized transmission and omni transmission mode.

72. The method as in any of the preceding embodiments, wherein implicit sectorized beam training is used wherein channel reciprocity is utilized.

73. The method as in any of the preceding embodiments, wherein implicit sectorized beam training results in the best receive sector also being the best sector for transmission.

74. The method as in any of the preceding embodiments, wherein implicit sectorized beam training between the STA and AP is initiated when the STA transmits a sector training announcement frame.

75. The method as in any of the preceding embodiments, wherein implicit sectorized beam training includes transmission of training frames following the sector training announcement frame.

76. The method as in any of the preceding embodiments, wherein implicit sectorized beam training includes the AP sending a sector response frame to the STA assigning a sector.

77. The method as in any of the preceding embodiments, wherein explicit sectorized beam training without channel reciprocity is used.

78. The method as in any of the preceding embodiments, wherein explicit sectorized beam training includes the AP multi-casts or broadcasts a sector training announcement frame, the AP transmits training frames.

79. The method as in any of the preceding embodiments, wherein explicit sectorized beam training includes STAs intending to enroll with sectorized transmissions or intending to change sectors sending feedback frames to the AP.

80. A STA configured to perform any of the methods of embodiments 1-79.

81. A base station configured to perform any of the methods of embodiments 1-79.

82. A network configured to perform any of the methods of embodiments 1-79.

83. An access point (AP) configured to perform any of the methods of embodiments 1-79.

84. An integrated circuit configured to perform any of the methods of embodiments 1-79.

85. A method for use in an access point (AP), the method comprising: enabling an AP to transmit and receive in a multi-access point (multi-AP) system;

receiving at the AP control messages from a central WLAN controller; and

utilizing a sectorized antenna mode in order to reduce interference amongst APs in the multi-AP system.

1-20. (canceled)

21. A method for use m an IEEE 802.11 station, the method comprising:
receiving a Sector Training Announcement frame from an access point (AP);
receiving a plurality of Training frames from the AP, wherein each of the plurality of Training frames is separated by a short interframe spacing (SIFS) and each of the plurality of Training frames is transmitted by the AP using a different sectorized antenna pattern;
generating a Sector Feedback frame indicating a preferred sector based on the plurality of Training frames; and
sending the Sector Feedback frame to the AP.

22. The method of claim 21, wherein separating each of the plurality of training frames by a SIFS allows the AP to transmit the plurality of training frames consecutively without interruption.

23. The method of claim 21, wherein the Sector Feedback frame indicates a desire to enroll in sectorized transmissions.

24. The method of claim 21, wherein the Sector Feedback frame indicates a desire to change sectors.

25. The method of claim 21, wherein the Sector Training Announcement frame indicates a number of Training frames that will follow the Sector Training Announcement frame.

26. The method of claim 21, wherein the Sector Training Announcement frame is transmitted using an omni transmission pattern.

27. The method of claim 21, wherein at least one of the plurality of Training frames includes only a short training field, a long training field, or a signal field, and does not include any medium access (MAC) layer information.

28. The method of claim 21, wherein at least one of the plurality of Training frames includes a countdown number that indicates a number of remaining Training frames.

29. The method of claim 21, wherein at least one of the plurality of Training frames includes a sector identifier (ID).

30. The method of claim 29, wherein the sector ID is included in a SIG field of the at least one of the plurality of Training frames.

31. An IEEE 802.11 station comprising:
a receiver configured to receive a Sector Training Announcement frame from an access point (AP);
the receiver further configured to receive a plurality of Training frames from the AP, wherein each of the plurality of Training frames is separated by a short interframe space (SIFS) and each of the plurality of Training frames is transmitted by the AP using a different sectorized antenna pattern;
a processor configured to generate a Sector Feedback frame indicating a preferred sector based on the plurality of Training frames; and
a transmitter configured to transmit the Sector Feedback frame to the AP.

32. The station of claim 31, wherein separating each of the plurality of training frames by a SIFS allows the AP to transmit the plurality of training frames consecutively without interruption.

33. The station of claim 31, wherein the Sector Feedback frame indicates a desire to enroll in sectorized transmissions.

34. The station of claim 31, wherein the Sector Feedback frame indicates a desire to change sectors.

35. The station of claim 31, wherein the Sector Training Announcement frame indicates a number of Training frames that will follow the Sector Training Announcement frame.

36. The station of claim 31, wherein the Sector Training Announcement frame is transmitted using an omni transmission pattern.

37. The station of claim 31, wherein at least one of the plurality of Training frames includes only a short training field, a long training field, or a signal field, and does not include any medium access (MAC) layer information.

38. The station of claim 31, wherein at least one of the plurality of Training frames includes a countdown number that indicates a number of remaining Training frames.

39. The station of claim 31, wherein at least one of the plurality of Training frames includes a sector identifier (ID).

40. The station of claim 39, wherein the sector ID is included in a SIG field of the at least one of the plurality of Training frames.
